(19) United States
(12) Patent Application Publication
(10) Pub. No.: US 2006/0155418 A1
(43) Pub. Date: Jul. 13, 2006

(54) Apparatus, method and article for direct slicing of step based nurbs models for solid freeform fabrication

(75) Inventors: Thomas J. Bradbury, Yardley, PA (US); Binil Starly, Philadelphia, PA (US); Wing K. Lau, Basking Ridge, NJ (US); Wei Sun, Cherry Hill, NJ (US); Alan C. Lau, Philadelphia, PA (US); Adolphe H. Youssef, Kendall Park, NJ (US); Christopher M. Gaylo, Princeton Junction, NJ (US)

Correspondence Address: MIDDLETON & REUTLINGER, 2500 BROWN & WILLIAMSON TOWER, LOUISVILLE, KY, 40202, US

(73) Assignee: Therics, Inc., Princeton, NJ (US)

(21) Appl. No.: 10/823,095

(22) Filed: Apr. 12, 2004

Related U.S. Application Data
(60) Provisional application No. 60/462,954, filed on Apr. 14, 2003.
(60) Provisional application No. 60/487,463, filed on Jul. 15, 2003.

(51) Int. Cl. G06F 19/00

(52) U.S. Cl. 700/182; 700/119

(57) ABSTRACT

Direct slicing of CAD models to generate process planning instructions for solid freeform fabrication may overcome inherent disadvantages of using STL format in terms of the process accuracy, ease of file management, and incorporation of multiple materials. This paper will present the results of our development of a direct slicing algorithm for layered freeform fabrication. The direct slicing algorithm was based on a neutral, international standard (ISO 10303) STEP-formatted NURBS geometric representation and is intended to be independent of any commercial CAD software. The following aspects of the development effort will be presented: 1) Determination of optimal build direction based upon STEP-based NURBS models; 2) Adaptive subdivision of NURBS data for geometric refinement; and 3) Ray-casting slice generation into sets of raster patterns. Feasibility studies applying the direct slicing algorithm to example models and the generation of fabrication planning instructions involving multi-material structures will also be presented.

### BACKGROUND OF THE INVENTION

1. Field of the Invention

This disclosure generally relates to the field of rapid prototyping and particularly to Layered Manufacturing (LM) or Solid Freeform Fabrication (SFF).

2. Description of the Related Art

Layered Manufacturing or Solid Freeform Fabrication, a new class of manufacturing techniques introduced during the mid 1980s has grown rapidly over the past decade because of its proven ability to reduce product development cycle time.

In the current industrial Rapid Prototyping (RP) practice, three-dimensional (3D) CAD data are first converted to an intermediate StereoLithography (STL) format, a tessellation procedure where the model is approximated by triangles, sliced and then fabricated by the machine. But with the rapid growth of the RP industry, particularly RP directed towards rapid manufacturing, rapid tooling and biomedical applications, there has been a growing dissatisfaction with this format among the RP community due to the limitations inherent within the format. The geometric description used to represent solid CAD objects significantly affects the accuracy and quality of the final parts produced with this technology especially in the case of freeform shapes. The limitation of the current STL format generated through a tessellation procedure of the CAD model is well noted in the published literature, for example, Anne L. Marsan, Vinod Kumar, Debasish Dutta, and Michael J. Pratt, “An Assessment of Data Requirements and Data Transfer Formats for Layered Manufacturing,” Technical Report NISTIR 6216, National Institute of Standards and Technology, Gaithersburg, Md. These limitations can be summarized as follows:

Tessellation involves approximation of surfaces with triangular facets which is undesirable in general, particularly when dealing with models that contain freeform shapes. As model precision demands become more stringent, the number of facets required to adequately approximate these freeform shapes will increase. This results in extremely large STL file sizes, which become increasingly difficult to manage and increases the possibility of one or more errors. Many CAD systems fail to generate valid model tessellations and often require the manual correction of errors, providing further motivation for improving tessellation procedures. However, this calls for implementing robust and efficient procedures which may be difficult and would be computationally expensive to implement. The STL format fails to include other design content within the model, such as topology, internal material variations, and/or multi-material regions.

Accuracy was not an issue that was addressed in the early days of RP simply because the parts could only be used for prototyping and design verification purposes. A wealth of research is available in published literature regarding STL slicing and the different methods through which STL slicing can be achieved. For example, Luo R C.; and Y. W. Ma, “A Slicing Algorithm for Rapid Prototyping and Manufacturing,” 1995 IEEE International Conf. on Robotics and Automation, Nagoya, Japan, May 1995, Vol. (3); pp 2841-2846; Suh, Yong Seok and Wozny, Michael J. “Adaptive Slicing for Solid Freeform Fabrication Processes,” Solid Freeform Fabrication Symposium 1993, H. L. Marcus et al., eds., University of Texas, Austin, August 1993, pp. 404-410; and Tait S, Smith, Rida T. Farouki, Mohammed Al-Khandari, “Optimal Slicing of free form surfaces,” Computer Aided Geometric Design (19), 2002, 43-64. However, improving the accuracy of an RP part has become the focus of the RP community under the increasing need for prototyping functional parts with engineering properties and dimensional tolerances comparable to conventionally produced parts. Thus, manufacturers of free form surface models are in need of some approach that reduces or eliminates the problems that result from the currently available STL format.

One among the first to try out direct slicing was Rajagopalan et al, who describe directly slicing the Non-Uniform Rational B-spline Surfaces (NURBS) in an I-DEAS based CAD system in their publication Rajagopalan, M., Aziz, N. M., Huey, C. O., “A model for interfacing geometric modeling data with rapid prototyping systems,” Advances in Engineering Software, Vol. 23, 1995; pp 89-96. The process relied on I-DEAS to perform the slicing which made it package-specific.

With regards to improving surface finish, variable thickness slicing methods (adaptive slicing) for handling peaks, flat areas and staircase effect have also been proposed by Dolenc and Makela in their publication Dolenc and I. Mäkelä, “Slicing procedures for layered manufacturing techniques,” Computer-Aided Design, Vol. 26(2), 1994; pp. 119-126.

Jamieson and Hacker developed a direct slicing algorithm based on the Unigraphics slice modules which directly sliced the model using at first constant layer thickness, as described in their publication Jamieson, R., Hacker, H. “Direct slicing of CAD models for rapid prototyping,” Rapid Prototyping Journal, Vol. 1(2), 1995. Consecutive contours were then compared and if the difference was small, they were accepted. If not, a middle slice is created and the process of comparison performed again. The procedure of adaptive slicing was repeated until the difference between any two consecutive slice contours is either small or the minimum layer thickness has been reached.

It has been recognized that in order to improve the surface quality of a part built by an LM technique, it is necessary to minimize the staircase effect which is inherent in all LM techniques. In a more recent study, Weiyin et al developed an adaptive direct slicing algorithm that operates directly on NURBS based models to generate skin contours and then used a selective hatching strategy to reduce the build time of the model as described in Weiyin M., Peiren M. “An adaptive slicing and selective hatching strategy for layered manufacturing,” Journal of Materials Processing Technology; Vol. 89, 1999; pp 191-197.

Almost all of the published papers cited above in some way depend on external modeling packages to perform the slicing which in turn limits the capability on the level of control and variety that can be achieved. A STEP-based transfer of model data to a process planning system has been made use of by Gilman et al using commercially available software as described in Gilman, Charles R. and Rock, Stephen J., “The Use of STEP to Integrate Design and Solid Freeform Fabrication,” Solid Freeform Fabrication Symposium, University of Texas, Austin, August 1995. A Boundary Representation (B-rep) solid model of a part is translated into STEP format for transfer of design data to the process planning software. LM data is generated using faceted boundary representation and then transferred to the RP machine for prototyping. It has been recommended that the development of STEP specifically for the purpose of LM process planning due to its flexibility in terms of representing 3D CAD data, as well as 2D contour slices, thereby simplifying the standardization procedure with one common platform as described in Anne L. Marsan, Vinod Kumar, Debasish Dutta, and Michael J. Pratt, “An Assessment of Data Requirements and Data Transfer Formats for Layered Manufacturing,” Technical Report NISTIR 6216, National Institute of Standards and Technology, Gaithersburg, Md.

### BRIEF SUMMARY OF THE INVENTION

Direct slicing of CAD models without the intermediate STL format seems to be a promising approach reducing or eliminating the problems associated with the currently available STL format. Direct slicing of the solid model keeps the geometric and topological robustness from the original data. Its advantages may include greater model accuracy, pre-processing time reduction, elimination of checking and repairing routines, and file size reduction as noted in the literature such as Jamieson, R., Hacker, H. “Direct slicing of CAD models for rapid prototyping,” Rapid Prototyping Journal, Vol. 1(2), 1995. Since the direct mathematical formulation of the surface is used, the full data of the original solid modeler is therefore available and the loss that occurs during tessellation is avoided. Both direct slicing and adaptive direct slicing improve the accuracy and surface quality of the final RP parts. The direct slicing approach may also eliminate the verification and repairing processes, decreases human intervention, increases the robustness of data transfer, slicing and other preprocessing parameters. With this approach of direct input from computer aided design models, CAD and RP vendors may be able to provide their software/machines as a fully integrated CAD/CAM RP system.

It would be desirable to have a method of direct slicing that is independent of any CAD modeling package, and which, for example, makes use of STEP as the starting input file of the model to be prototyped. The below description focuses on NURBS based freeform shapes to demonstrate the capability of the disclosed algorithm and the proposed methodology with regards to raster line pattern layout, but may be applied to other representations. The proposed methodology of direct slicing is set out in the detailed description, followed by a review of the NURBS equations that need to be numerically solved to obtain the slice ray patterns during the slicing operation. The key steps of optimal orientation, adaptive refinement, root finding and evaluation of points are also described. The detailed description provides examples by the way of several case studies of exemplary models that are sliced to illustrate the described direct slicing method.

### BRIEF DESCRIPTION OF THE SEVERAL VIEWS OF THE DRAWINGS

FIG. 1 is a schematic diagram of a biomedical device design, manufacturing and/or selection system including a client computing system and a host computing system having a server computer and a CAD workstation.

FIG. 2 is schematic diagram showing a procedure of calculating NURBS intersection points according to one illustrated embodiment.

FIG. 3 is a flow diagram illustrating an overall slicing algorithm according to one illustrated embodiment.

FIG. 4A is a flow diagram of an optimization algorithm according to one illustrated embodiment.

FIG. 4B is a schematic diagram contrasting a sliced non-optimized model of an object with a sliced model of the object optimized according to the algorithm of FIG. 4A.

FIG. 5 is an isometric view of a surface of a model showing an original set of control points and a set of control points after applying a refined process of NURBS using the Oslo Algorithm according to one illustrated embodiment.

FIG. 6 is a schematic diagram of a process flow during fabrication.

FIG. 7A is an isometric view of a first exemplary three-dimensional model comprising 16 NURBS surfaces and showing a slice plane passing through the first model.

FIG. 7B is slice layout view of the first model on a fabrication bed at a slice position defined by the slice plane of FIG. 7A.

FIG. 7C is an isometric view of the first model showing a number of entry and exit points.

FIG. 8A is an isometric view of a second exemplary three-dimensional model comprising 102 NURBS surfaces and showing a slice plane passing through the second model.

FIG. 8B is slice layout view of the second model on a fabrication bed at a slice position defined by the slice plane of FIG. 8A.

FIG. 8C is an isometric view of the second model showing a number of entry and exit points.

FIG. 9A is an isometric view of a third exemplary three-dimensional model comprising 135 NURBS surfaces and showing a slice plane passing through the third model.

FIG. 9B is slice layout view of the third model on a fabrication bed at a slice position defined by the slice plane of FIG. 9A.

FIG. 9C is an isometric view of the third model showing a number of entry and exit points.

FIG. 10 is a block diagram of a slicing algorithm that may be implemented in software as a number of files or routines according to one illustrated embodiment.

FIG. 11 is a flow diagram of a preparation and slicing procedure according to one illustrated embodiment.

FIGS. 12A and 12B are a flow diagram of a method of implementing a main file or routine according to one illustrated embodiment.

FIG. 13 is a flow diagram of a NURBS Division file or routine according to one illustrated embodiment.

FIG. 14 is a flow diagram of a method of executing a Do Subdivision routine or procedure callable by the NURBS Division file or routine of FIG. 13.

FIG. 15 is a flow diagram of an Emit Triangles file or routine according to one illustrated embodiment.

FIG. 16 is a flow diagram of a Reading Bounding Boxes file or routine according to one illustrated embodiment.

FIG. 17 is a flow diagram of a Calculate Hit Point file or routine according to one illustrated embodiment.

FIGS. 18A and 18B are a flow diagram of a Calculate Hit Point file or routine according to another illustrated embodiment.

FIGS. 19A-19D are a flow diagram of a Data Sort file or routine according to one illustrated embodiment.

FIG. 20 is a screen print of a model of a sphere comprising a number of NURBS surfaces according to one illustrated embodiment.

FIG. 21 is a screen print of a data output formal from a Solidworks macro according to one illustrated embodiment.

FIG. 22 is a screen print of a subdivision procedure executing on the model of the sphere according to one illustrated embodiment.

FIG. 23 is a screen print of a slicing procedure executing on the model of the sphere according to one illustrated embodiment.

FIG. 24 is a screen print of a ray cast file for the model of the sphere according to one illustrated embodiment.

FIG. 25A is a screen print of the model of the sphere and a format box listing process parameters for the slicing of the model according to one illustrated embodiment.

FIG. 25B is a screen print of a raster pattern resulting from the slicing of the model of the sphere of FIG. 25A, according to one illustrated embodiment.

FIG. 26A is a screen print of the model of a cone and a format box listing process parameters for the slicing of the model according to one illustrated embodiment.

FIG. 26B is a screen print of a raster pattern resulting from the slicing of the model of the cone of FIG. 26A, according to one illustrated embodiment.

FIG. 27A is a screen print of the model of a portion of a foot and a format box listing process parameters for the slicing of the model according to one illustrated embodiment.

FIG. 27B is a screen print of a raster pattern resulting from the slicing of the model of the portion of a foot of FIG. 27A, according to one illustrated embodiment.

FIG. 28A is a screen print of a model of a first sinus graft and a format box listing process parameters for the slicing of the model according to one illustrated embodiment.

FIG. 28B is a screen print of a raster pattern resulting from the slicing of the model of the first sinus graft of FIG. 28A, according to one illustrated embodiment.

FIG. 29A is a screen print of a model of a second sinus graft and a format box listing process parameters for the slicing of the model according to one illustrated embodiment.

FIG. 29B is a screen print of a raster pattern resulting from the slicing of the model of the second sinus graft of FIG. 29A, according to one illustrated embodiment.

FIG. 30A is a screen print of a model of a third sinus graft and a format box listing process parameters for the slicing of the model according to one illustrated embodiment.

FIG. 30B is a screen print of a raster pattern resulting from the slicing of the model of the third sinus graft of FIG. 30A, according to one illustrated embodiment.

FIG. 31A is a screen print of a model of a fourth sinus graft and a format box listing process parameters for the slicing of the model according to one illustrated embodiment.

FIG. 31B is a screen print of a raster pattern resulting from the slicing of the model of the fourth sinus graft of FIG. 31A, according to one illustrated embodiment.

FIG. 32A is a screen print of a model of a bone with holes formed therein, and a format box listing process parameters for the slicing of the model according to one illustrated embodiment.

FIG. 32B is a screen print of a raster pattern resulting from the slicing of the model of the bone with holes of FIG. 32A, according to one illustrated embodiment.

FIG. 33A is a screen print of a model formed from a combination of bones, and a format box listing process parameters for the slicing of the model according to one illustrated embodiment.

FIG. 33B is a screen print of a raster pattern resulting from the slicing of the model of the combination of bones of FIG. 33A, according to one illustrated embodiment.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with computing systems including CAD computing systems, fabrication systems, for example 3-D printing systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

System Environment

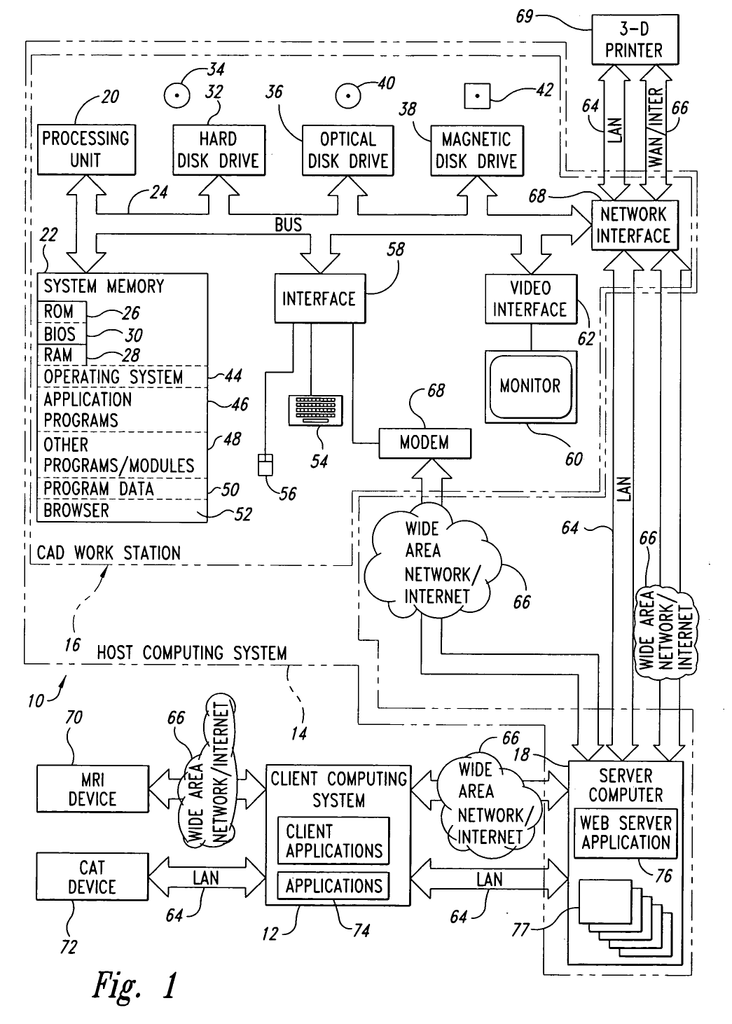

FIG. 1 and the following discussion provide a brief, general description of a suitable computing environment in which embodiments of the invention can be implemented. Although not required, embodiments of the invention will be described in the general context of computer-executable instructions, such as program application modules, objects, or macros being executed by a computer. Those skilled in the relevant art will appreciate that the invention can be practiced with other computer system configurations, including hand-held devices, multiprocessor systems, microprocessor-based or programmable consumer electronics, personal computers (“PCs”), network PCs, mini computers, mainframe computers, and the like. The invention can be practiced in distributed computing environments where tasks or modules are performed by remote processing devices, which are linked through a communications network. In a distributed computing environment, program modules may be located in both local and remote memory storage devices.

Referring to FIG. 1, a rapid prototyping system in the form of an exemplary biomedical device design and manufacturing system 10 includes a client computing system 12 and a host computing system 14. The client computing system 12 may be located at a diagnostic site, such as a hospital, clinic, laboratory or doctor's office. The host computing system 14 may be located at a site remote from the diagnostic site, such as at a site of a biomedical device designer or manufacturer.

The host computing system 14 includes a conventional mainframe or mini-computer, referred to herein as the computer aided design (“CAD”) workstation 16 and a server computer 18. While shown as separate devices, the server functionality can be implemented within the CAD workstation 16, which may reduce the cost of the system 10, but may also cause an unacceptable degradation in system performance.

The CAD workstation 16 includes a processing unit 20, a system memory 22 and a system bus 24 that couples various system components including the system memory 22 to the processing unit 20. The CAD workstation 16 and/or server computer 18, will at times be referred to in the singular herein, but this is not intended to limit the application of the invention to a single CAD workstation 16 and/or server computer 18 since in typical embodiments, there will be more than one CAD workstation 16 and/or server computer 18.

The biomedical device design and manufacturing system 10 may employ other computers, such as conventional personal computers, where the size or scale of the system allows. The processing unit 20 may be any logic processing unit, such as one or more central processing units (CPUs), digital signal processors (DSPs), application-specific integrated circuits (ASICs), etc. Unless described otherwise, the construction and operation of the various blocks shown in FIG. 1 are of conventional design. As a result, such blocks need not be described in further detail herein, as they will be understood by those skilled in the relevant art.

The system bus 24 can employ any known bus structures or architectures, including a memory bus with memory controller, a peripheral bus, and a local bus. The system memory 22 includes read-only memory (“ROM”) 26 and random access memory (“RAM”) 28. A basic input/output system (“BIOS”) 30, which can form part of the ROM 26, contains basic routines that help transfer information between elements within the CAD workstation 16, such as during start-up.

The CAD workstation 16 also includes a hard disk drive 32 for reading from and writing to a hard disk 34, and an optical disk drive 36 and a magnetic disk drive 38 for reading from and writing to removable optical disks 40 and magnetic disks 42, respectively. The optical disk 40 can be a CD-ROM, while the magnetic disk 42 can be a magnetic floppy disk or diskette. The hard disk drive 34, optical disk drive 40 and magnetic disk drive 42 communicate with the processing unit 20 via the bus 24. The hard disk drive 32, optical disk drive 36 and magnetic disk drive 38 may include interfaces or controllers (not shown) coupled between such drives and the bus 24, as is known by those skilled in the relevant art. The drives 32, 36 and 38, and their associated computer-readable media 34, 40, 42, provide nonvolatile storage of computer readable instructions, data structures, program modules and other data for the CAD workstation 16. Although the depicted CAD workstation 16 employs hard disk 34, optical disk 40 and magnetic disk 42, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 22, such as an operating system 44, one or more application programs 46, other programs or modules 48 and program data 50. The system memory 16 may also include a Web client or browser 52 for permitting the CAD workstation 16 to access and exchange data with sources such as Web sites of the Internet, corporate intranets, or other networks as described below, as well as other server applications on server computers including the server computer 18, such as those further discussed below. The browser 52 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as NETSCAPE NAVIGATOR from America Online, and INTERNET EXPLORER available from Microsoft of Redmond, Wash.

While shown in FIG. 1 as being stored in the system memory 22, the operating system 44, application programs 46, other programs/modules 48, program data 50 and browser 52 can be stored on the hard disk 34 of the hard disk drive 32, the optical disk 40 of the optical disk drive 36, the magnetic disk 42 of the magnetic disk drive 38 and/or other computer-readable media. An operator, such as a mechanical engineer or technician, can enter commands and information into the CAD workstation 16 through input devices such as a keyboard 54 and a pointing device such as a mouse 56. Other input devices can include a microphone, joystick, game pad, scanner, etc. These and other input devices are connected to the processing unit 20 through an interface 58 such as a serial port interface that couples to the bus 24, although other interfaces such as a parallel port, a game port or a wireless interface or a universal serial bus (“USB”) can be used. A monitor 60 or other display device is coupled to the bus 24 via a video interface 62, such as a video adapter. The CAD workstation 16 can include other output devices, such as speakers, printers, etc.

The CAD workstation 16 can operate in a networked environment using logical connections to one or more remote computers, such as the server computer 18 and client computing system 12. The server computer 18 can be another personal computer, a server, another type of computer, or a collection of more than one computer communicatively linked together and typically includes many or all of the elements described above for the CAD workstation 16. The server computer 18 is logically connected to one or more of the client computing systems 12 and CAD workstations 16 under any known method of permitting computers to communicate, such as through a local area network (“LAN”) 64, or a wide area network (“WAN”) or the Internet 66. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a LAN networking environment, the CAD workstation 16 is connected to the LAN 64 through an adapter or network interface 68 (communicatively linked to the bus 24). When used in a WAN networking environment, the CAD workstation 16 may include a modem 68 or other device, such as the network interface 68, for establishing communications over the WAN/Internet 66. The modem 68 is shown in FIG. 1 as communicatively linked between the interface 58 and the WAN/Internet 66. In a networked environment, program modules, application programs, or data, or portions thereof, can be stored on, or passed through, the server computer 18. In the depicted embodiment, the CAD workstation 16 is communicatively linked to the server computer 18 through the LAN 64 or the WAN/Internet 66 with TCP/IP middle layer network protocols; however, other similar network protocol layers are used in other embodiments, such as User Datagram Protocol (“UDP”). Those skilled in the relevant art will readily recognize that the network connections shown in FIG. 1 are only some examples of establishing communication links between computers, and other links may be used, including wireless links.

The host computing system 14 include one or more peripheral devices for producing biomedical devices based on the digital models. For example, host computing system 14 may include a 3-dimensional printer 69 coupled to the CAD workstation 16 to receive machine instructions over the LAN 64 and/or WAN or Internet 66.

The client computing system 14 contains many of the same or similar structures, systems and subsystems as the CAD workstation 16, thus only the differences will be discussed in detail. The client computing system 14 is communicatively linked to a first biomedical sensor, such as an MRI device 70, typically through the LAN 64 or the WAN/Internet 66 or other networking configuration such as a direct asynchronous connection (not shown). The client computing system 14 may also be communicatively linked to a second biomedical sensor, such as a CT device 24, typically through the LAN 64 or the WAN/Internet 66 or other networking configuration such as a direct asynchronous connection (not shown). While not illustrated, the client computing system 14 may include more than one computer, and may include a server (not shown) for networking a number of client computers. The client computing system 14 may include client software applications 73 for resolving, managing or manipulating the diagnostic data from the MRI device 70 and/or CT device 72. The client computing system 14 may include software applications for communicating with the CAD workstation 16, for example, a browser 74. The software applications can be stored on any of a variety of computer-readable media.

The server computer 18 contains many of the same or similar structures, systems and subsystems as the CAD workstation 16, thus only the differences will be discussed in detail. The server computer 18 includes server applications 76 for the routing of instructions, programs, data and agents between the MRI device 70, CT device 72, client computing system 12 and CAD workstation 16. For example the server applications 76 may include conventional server applications such as WINDOWS NT 4.0 Server, and/or WINDOWS 2000 Server, available from Microsoft Corporation of Redmond, Wash. Additionally, or alternatively, the server applications 76 can include any of a number of commercially available Web servers, such as INTERNET INFORMATION SERVICE from Microsoft Corporation and/or IPLANET from Netscape. The server computer 18 also includes one or more secure Webpages 77, serving as a user interface (“UI”) for exchanging data, information and requests between the diagnostic and/or clinical sites and the design and/or manufacturing sites. The server applications 76 and/or Webpages 77 can be stored on any of a variety of computer-readable media.

Direct Slicing of NURBS Using Ray Casting

Non-Uniform Rational B-Spline (NURBS) surfaces are the industry standard tools for the representation and computer aided-design of freeform models in the field of automotive design, ship design etc, as noted in Rogers D F, “Introduction to NURBS: with Historical Perspective,” Morgan Kaufmann Press, 2000, ISBN 1558606696.

Central to the problem of slicing NURBS surfaces is the determination of intersection points between the slicing plane and the model. This is also a problem that is the subject of research by the computer graphics community with regards to ray-tracing of NURBS surfaces. For example, Kajiya J T, “Ray tracing parametric patches,” Computer Graphics SIGGRAPH '82 Proceedings, Vol. 16(3), 1982; pp 245-254; Daniel L, Jacob Gonczarowski, “Improved techniques for ray tracing parametric surfaces,” The visual computer, Vol. 6(3), 1990; pp 134-152; Michael A J Sweeney, Richard Bartels, “Ray tracing free form B-spline surfaces,” IEEE Computer Graphics & Applications, Vol. 6(2), 1986; and William M, Elaine C, Russell F, Peter S, “Practical Ray tracing of Trimmed NURBS surfaces,” Journal of Graphics Tools, Vol. 5(1), 2000, pp 27-52 discuss the determination of intersection points between the slicing plane and the model with regard to ray-tracing of NURBS surfaces.

Ray tracing of free form surfaces determines the visible parts by constructing rays from the viewpoint through the pixels of the image plane into the scene. The rays are intersected with the surfaces of the scene and the first surface hit determines the color of the pixel. If the ray misses all objects, the corresponding pixel is shaded with the background color. Ray tracing handles shadows, multiple specular reflections, and texture mapping in a very easy straight-forward manner. This is important to the designer since it would help the designer assess the surface quality and texture and hence help in a better design process.

The basic approaches in most ray-tracing algorithms with regard to determination of the intersection points remain the same and only vary with regard to efficiency in terms of memory usage and the speed taken to ray trace a particular scene. Most ray tracing algorithms perform while tessellating freeform shapes to gain speed and reduce complexity. However direct intersection using the exact mathematical equations has also been suggested as discussed in William M, Elaine C, Russell F, Peter S, “Practical Ray tracing of Trimmed NURBS surfaces,” Journal of Graphics Tools, Vol. 5(1), 2000; pp 27-52.

The below described methodology employs the same basic approach using the exact mathematical equations to deal with finding the intersection points. The below described approach, however, extends to the slicing domain for use in the LM manufacturing scenario. One significant difference arises from the fact that in LM, intersection points both in the form of entry and exit points need to be determined along with the vector layout pattern of the rays within the model. Rather than a tracing operation, a ray casting method is performed in order to perform the slicing procedure.

Within STEP files, solid and surface models may be represented as rational or non-uniform rational B-spline surfaces. Unlike STL files where the facet information of the triangle is used to obtain the slice contour, direct slicing works using the exact mathematic representation of the freeform shapes in computing the slice contours or tool patterns. A rational B-spline surface (10) is expressed parametrically in the form,

$$S ( u , v ) = \frac{{\sum }_{i = 1}^{n + 1} {\sum }_{j = 1}^{m + 1} {W}_{ij} {P}_{ij} {b}_{ik} ( u ) {b}_{jl} ( v )}{{\sum }_{i = 1}^{n + 1} {\sum }_{j = 1}^{m + 1} {W}_{ij} {b}_{ik} ( u ) {b}_{jl} ( v )} \qquad ( 1 )$$

where parameters u and v range from zero to one, n and m the degree of the surface in u and v direction. The Pᵢⱼ terms are 3D net control points of the control polygon and Wᵢⱼ terms their corresponding weights, bᵢₖ and bⱼₗ are B-spline basis functions of order k and l respectively. The B-spline basis functions are defined by the Cox-deBoor recursion formulas as given by:

$${b}_{j 1} ( s ) = \{ \begin{matrix}1 & if {ku}_{j} \leq u \leq {ku}_{j + 1} \\ 0 & otherwise\end{matrix} \\ {b}_{l 1} ( s ) = \{ \begin{matrix}1 & if {kv}_{l} \leq u \leq {kv}_{l + 1} \\ 0 & otherwise\end{matrix} \\ and \\ \begin{matrix}{b}_{jk} ( u ) = \frac{( u - {ku}_{j} ) {b}_{( j ) ( k - 1 )} ( u )}{{ku}_{j + k - 1} - {ku}_{j}} + \\ \frac{( {ku}_{j + k + 1} - u ) {b}_{( j + 1 ) ( k - 1 )} ( u )}{{ku}_{j + k + 1} - {ku}_{j + 1}} \\ {b}_{lk} ( v ) = \frac{( v - {kv}_{l} ) {b}_{( l ) ( k - 1 )} ( v )}{{kv}_{l + k - 1} - {kv}_{l}} + \\ \frac{( {kv}_{l + k + 1} - v ) {b}_{( l + 1 ) ( k - 1 )} ( v )}{{kv}_{l + k + 1} - {kv}_{l + 1}}\end{matrix} \qquad ( 2 )$$

where the values of kuⱼ and kvₗ are defined by the knot vector associated with the NURBS surface in the u and v direction respectively. The STEP file contains all information that is required to define the NURBS uniquely and a STEP reader extracts the relevant information. For further discussion on B-splines and their properties see Daniel L, Jacob Gonczarowski, “Improved techniques for ray tracing parametric surfaces,” The visual computer, Vol. 6(3), 1990; pp 134-152.

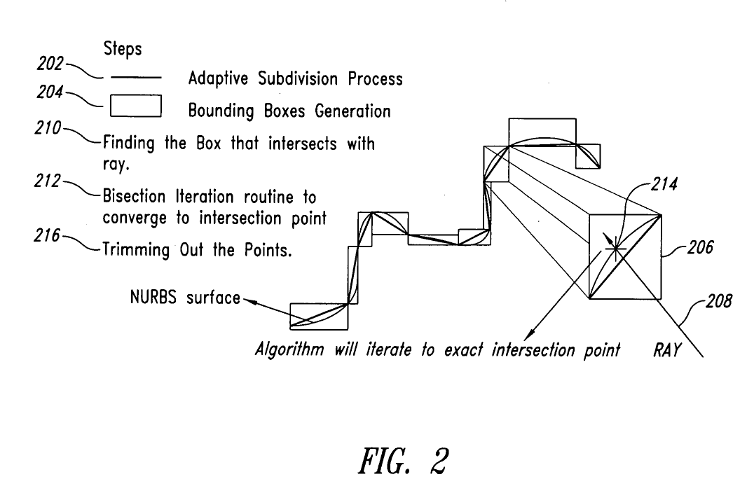

FIG. 2 illustrates some aspects of the new approach taught herein. While the process typically takes place in three dimensions, FIG. 2 illustrates the process in two dimensions for the sake of clarity of presentation.

A computing system such as the CAD workstation 16 (FIG. 1) geometrically refines the NURBS surfaces (i.e., model) 100 using an adaptive subdivision procedure in step 202, breaking the surfaces 100 down into smaller domains of parametric values. In step 204, the CAD workstation 16 covers the entire surface 100 with bounding boxes 206 based on the smaller domains. The rays 208 shoot out intersecting the model 100 at several boxes 206. In step 210, the CAD workstation 16 finds the bounding boxes 206 where the rays 208 intersects the model 100. For each bounding box 206 that is intersected, the CAD workstation 16 initiates a root finding procedure in step 212, to converge at the intersection point 214. In step 216, the CAD workstation 16 trims unnecessary points out of the model 100. The procedure is repeated for all rays 208 that are cast onto the slice plane and for every slice plane that intersects the NURBS model 100.

Ray Casting of NURBS Surfaces

In the ray casting approach, the CAD workstation 16 first determines the bounding box 206 of the model 100, allowing the start position of the ray 208 to be defined from any predefined corner of the box 206 which then shoots out across intersecting the model. A ray 208 is defined as having an origin ‘o’ and a unit direction vector ‘d’ and can be defined as:
r(s)=\overline{o}+s*\overline{d} (3)
Using the method followed by Kajiya described in Kajiya J T, “Ray tracing parametric patches,” Computer Graphics SIGGRAPH '82 Proceedings, Vol. 16(3), 1982; pp 245-254, the ray r(s) can be rewritten as an intersection between 2 planes given by {p| P₁.(p,1)=0} and {p| P₂.(p,1)=0} where P₁=(N₁,d₁) and P₂=(N₂,d₂). The normal to the first plane is defined as

$${N}_{1} = \{ \begin{matrix}( {d}_{y} , - {d}_{x} , 0 ) & if \vert {d}_{x} \vert > \vert {d}_{y} \vert and \vert {d}_{x} \vert > \vert {d}_{z} \vert \\ ( 0 , {d}_{z} , - {d}_{y} ) & otherwise\end{matrix} \qquad ( 4 )$$

N₂ will always be perpendicular to the ray direction and the plane N₁, hence
\overline{N₂}=\overline{N₁}×\overline{d} (5)
Since both planes contain the origin ‘\overline{o}’, it can be deduced that P1.(o,1)=P2.(o,1)=0. Thus,
d₁=−\overline{N₁}·\overline{o}
d₂=−\overline{N₂}·\overline{o} (6)
An intersection point 214 that needs to be calculated should satisfy the following two conditions,
\overline{P₁}·(S(u,v),1)=0
\overline{P₂}·(S(u,v),1)=0 (7)

The CAD workstation solves the above equation using numerical techniques and the Bisection Iteration routine is employed to determine the values of u and v that will satisfy (7). However before the root finding operation begins, the CAD workstation 16 performs a number of pre-processing steps. Details regarding optimal orientation, refinement using adaptive subdivision, generation of the bounding volumes, root finding, evaluation and identification of output points are set out below.

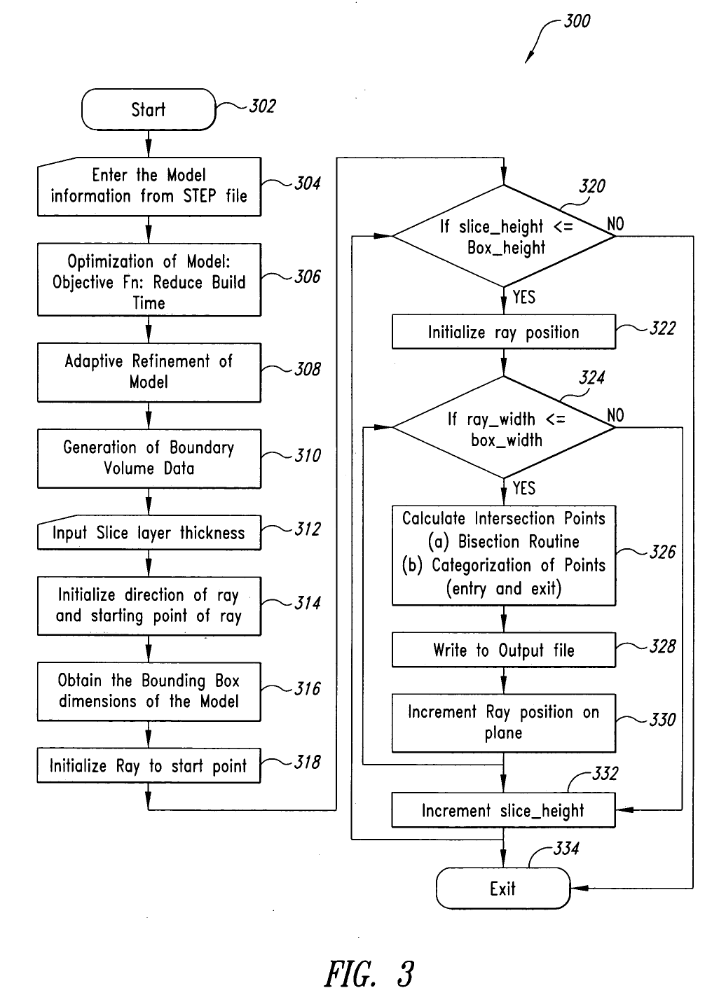

FIG. 3 shows the general slicing algorithm 300, starting in step 302, and receiving the model information from a STEP file in step 304. The slicing algorithm 300 is discussed with reference to the CAD workstation 16 (FIG. 1), although one skilled in the art will recognize that other computing systems may be suitable.

Orientation

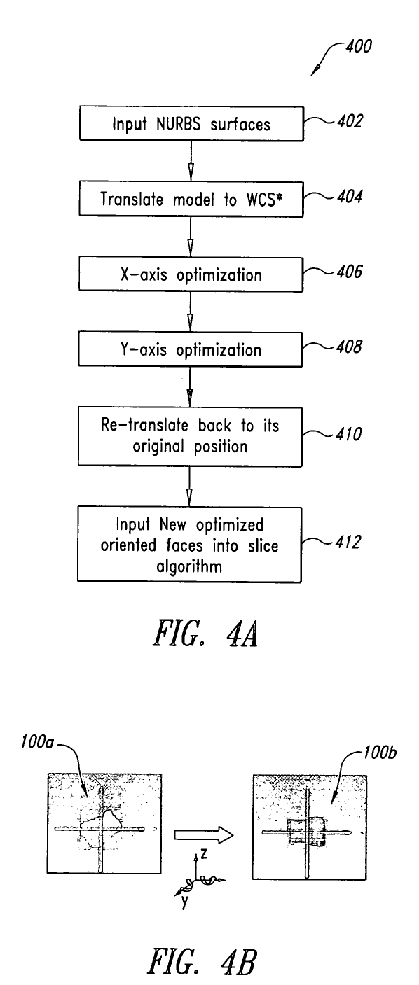

In step 306, the CAD workstation 16 optimizes the model 100 as discussed in detail below with reference to FIGS. 4A and 4B.

The model orientation within the fabrication bed affects the build time, part strength in different directions and surface finish. Thus before the part is sliced, a minimization of certain objective criteria specified by the designer will be done to find the optimal orientation for slicing the model. Finding the optimal build orientation of an object requires the minimization of some objective function over all possible orientations. The objective function would include a variety of parameters such as Build Height, volume of supports, surface area that will be affected by stair case effect. Optimizing all parameters at once will not be possible, hence some parameter is preferred over the other and this is done by giving weights to each parameter involved and then optimizing the overall objective function.

A number of orientation schemes have been devised. Some base their orientation with the largest convex hull of the object as the base such as discussed in Sreeram, Puduhai N. and Dutta, D., “Determination of Optimal Orientation Based on Variable Slicing Thickness in Layered Manufacturing,” Proceedings of the ASME Winter Annual Conference, San Francisco, Calif.; November 1995, while some others orient the part based on certain critical features of the model such as discussed in Frank, Dietmar and Fadel, Georges, “Preferred Direction of Build for Rapid Prototyping Processes,” Proceedings of the Fifth International Conference on Rapid Prototyping, R. P. Chartoff, A. J. Lightman, and J. A. Schenk, eds. University of Dayton, June 1994; pp. 191-200.

FIGS. 4A and 4B illustrate an optimization approach in which the NURBS model is incrementally oriented about user specified axes to obtain the least possible build height dimension, which may result in faster fabrication time and increased base area while fabricating.

Given a set of n NURBS surfaces S(u,v) that is enclosed in a bounding box of height H (a function of orientation angle “θ”), the objective function can be mathematically expressed as:
Min Z=H(θ) subject to 0<θ<360 (8)
where Z is the build height of the model and θ is the orientation of the model with respect to the object coordinate axes.

In an optimization method 400 set out in FIG. 4A, a CAD workstation system 16 (FIG. 1) receives a model 100a in the form of NURBS surfaces as input in step 402. In step 404, the CAD workstation system 16 translates the model 100a to the World Coordinate System (WCS).

In step 406, the CAD workstation system 16 performs an optimization of the X-axis. For example, the model 100a is rotated in the x-direction and the orientation which produces the least z-height is selected. This may employ an algorithm run from 0 to 360 degrees in incremental steps. Model transformation is achieved by the following simple transformation law about the x-axis:

$$[ \begin{matrix}{X}^{′} \\ {Y}^{′} \\ {Z}^{′}\end{matrix} ] = [ \begin{matrix}1 & 0 & 0 \\ 0 & cos ( θ ) & - sin ( θ ) \\ 0 & sin ( θ ) & cos ( θ )\end{matrix} ] [ \begin{matrix}X \\ Y \\ Z\end{matrix} ]$$

Here X, Y, Z represent the control points of the different NURBS surfaces that make up the model. (X′,Y′,Z′) represents the new control points after transformation. “Θ” represents the angle of transformation by which the control points needs to be rotated by.

In step 408, the CAD workstation system 16 performs an optimization of the Y-axis. For example, the x-optimized model is rotated about the y-direction from 0 to 360 degrees and the orientation with the least z-height is selected in incremental steps. Model transformation is achieved by the following simple transformation law about the y-axis (only a slight change in the elements of the matrix):

$$[ \begin{matrix}{X}^{′} \\ {Y}^{′} \\ {Z}^{′}\end{matrix} ] = [ \begin{matrix}cos ( θ ) & 0 & - sin ( θ ) \\ 0 & 1 & 0 \\ sin ( θ ) & 0 & cos ( θ )\end{matrix} ] [ \begin{matrix}X \\ Y \\ Z\end{matrix} ]$$

In step 410, the CAD workstation system 16 re-translates the optimized model 100b back to its original position. In step 412, the CAD workstation system 16 provides the optimally oriented NURBS faces 100b as the input to a second phase, discussed below with continuing reference to the general slicing algorithm 300 illustrated in FIG. 3.

FIG. 4B shows that an exemplary model 100a sliced with no optimization in its orientation generates 42 layers, while the exemplary model 100b sliced after its orientation is optimized generates only 32 layers.

Refinement

In step 308, the CAD workstation 16 performs adaptive refinement on the model 100b. Refinement or subdivision of the NURBS surface is the addition of more control points to a surface without changing its process. The CAD workstation 16 may use the Oslo Algorithm, discussed more fully in Bartels R, John B and Brian B, “An introduction to splines for Use in computer graphics and geometric modeling,” Morgan Kaufmann Press, Los Altos, Calif., 1987; ISBN 1558604006. The underlying idea is to take in the original set of knot vectors that make up the surface and add new knot values into them creating a greater number of control points corresponding to the new knot vectors. If the addition of the new knot values at the same parametric value where the number added is equal to the order of the curve, then the two new surfaces created will have the same shape as the original unrefined surface. They would each have a set of control points at the region where they join.

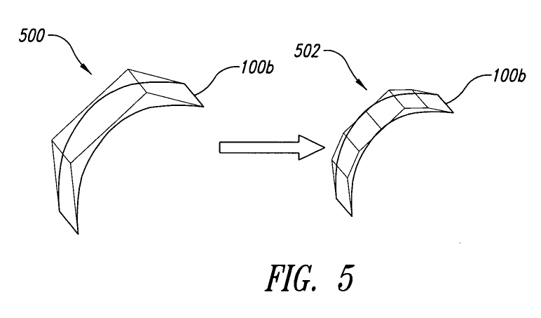

FIG. 5 illustrates the refinement procedure of step 308, showing an original set of control points 500 on a surface 100b and a refined set of control points 502 on the surface 100b. The refinement is performed for at least two reasons. Firstly, numerical methods work better and faster when the parametric domain is smaller and no multiple value roots exists within the patch. Secondly, by refining the mesh, the various sub-patches which are essentially NURBS by themselves can be enclosed using bounding volumes thereby enabling the slice algorithm to determine which sub-patch contains the actual root. This results from the fact that it is easier to determine the collision of rays with primitive bounding volumes than NURBS surfaces. Hence by identifying the sub-patch in which the solution exists, the domain in which the numeric solver has to work is limited and hence results in better chances of finding the roots.

The adaptive subdivision of the NURBS surface continues as long as a subdivision or flatness criteria is met. Regions that have more curvature are subdivided more than regions that are more or less flat and hence the name adaptive subdivision. Each new sub-patch contains all information that defines the NURBS and an appropriate ID is given to it. The refinement procedure is extensively used in the tessellation of parametric surfaces and has been studied extensively by a number of researchers. However, our main criteria in refinement of the mesh opposed to the tessellation procedure is not to ensure accuracy in representation but more in guaranteeing that the convergence occurs within the refined sub-patch. In this regard, selection of the subdivision factor is an important step, and an appropriate value controls to a great extent the success of accurate slicing.

Boundary Volume Data Structure Generation

As the refinement procedure of NURBS progresses, the boundary volume data structure gets filled up in step 310; sub-patches are stored in the data structure along with a unique identifier. The main idea behind the storage of these sub-patches is the generation of the boundary volume. Boundary volumes are usually primitives that enclose the sub-patch completely. Some of the candidate primitives that can be used are oriented boxes, spheres, parallelepipeds. The selection of a primitive depends on the tightness of fit and speed of intersection calculation with the ray. The described approach employs axis aligned boxes that are oriented with the main coordinate axis of the model. Once they are axis aligned, the process of creating the boundary volumes is easier, and a ray-box intersection will involve less computation and hence speed up the process.

The bounding box 206 is created using the control net points created from the refinement stage of the process. An important aspect to note is that the control mesh of a NURBS patch will always enclose the surface and therefore any convex shape surrounding the control net would also enclose the surface. FIG. 4B illustrates in 2D on how the boxes are generated. Failure to enclose the sub-patch surface completely, results in ray hits being missed and hence gaps in the sliced model.

In step 312, the slicer layer thickness is input to the CAD workstation 16, either manually or automatically. In step 314, the CAD workstation 16 initializes the direction and starting point of the ray. In step 316, the CAD workstation 16 obtains the dimensions of the bounding box 206 for the model 100. In step 318, the CAD workstation 16 initializes the ray to a start point. In step 320, the CAD workstation 16 determines if height of the slice is less than or equal the height of the box, and if not, then exiting the algorithm 300 in step 334. Otherwise, the CAD workstation 16 initializes the ray position in step 322. In step 324, the CAD workstation 16 determines if the width of the ray is less than or equal the width of the box, and if not increments the slice height in step 332.

In step 326, the CAD workstation 16 calculates the intersection points as discussed below. In step 328, the CAD workstation 16 writes to an output file. In step 330, the CAD workstation 16 increments the ray position on the plane.

Numerical Solution—Bisection Iteration Routine

There are a variety of numerical methods that are available to solve for the intersection points. Among them include bisection algorithm, linear interpolation, Newton Iteration, and fixed point iteration as discussed in William H P, Saul A, Wm T, Brian P, “Numerical recipes in C: the art of scientific computing,” Cambridge University Press; 2nd edition, 1993, ISBN 0-521-43108-5. Although the latter two methods are fast, in some cases they do result in solution divergence rather than convergence. The problem reduces to finding the value (u*, v*) that corresponds to the intersection point of the ray and the NURBS surface. Although ray tracing methods in model rendering may employ Newton's iteration since it proves to be a faster process, the bisection iteration routine provides simplicity and robustness. Typically, time is not a critical factor in slicing as opposed to obtaining the roots of the equation.

In step 326 (FIG. 3), the CAD workstation 16 calculates intersection points employing a bisection routine and categorization of those points as entry/exit points. The surface sub-patch contained within the boxes 206 (FIG. 2) that were hit by the ray 208 are retrieved from the boundary volume data structure and passed to the solver routine. The solver routine works by iterating towards the solution of one variable. However, we need to solve for 2 variables (u, v) that satisfy the equation. This is achieved by keeping one variable constant and iterating towards the best value of the second variable that satisfies the equation. If the error in the points generated does not satisfy a tolerance, ε, the first variable is incremented by a pre-defined amount and the procedure repeated. The process continues until either a solution is found or the limit of the first variable is achieved.

Two criteria are used to decide when to terminate the Bisection iteration routine. The first condition the success criteria: if we are closer to the desired point by some determined tolerance, ε, given by:
|F(u,v)|<ε (9)
a successful hit is reported. The value of ε determines two aspects, first, the accuracy of the results and second, success in reporting a hit. A tight value might result in the routine reporting a miss and on the other hand a bigger tolerance will result in intersection point offset errors. The second condition is the failure criterion, meaning that if this condition is met, the routine exits reporting a miss. If during the routine, the error calculated is approximately same as the error in the previous iteration, the iteration exits reporting a miss provided the success criteria has not been met. This is mathematically written as
Fₙ(u,v)=Fₙ₋₁(u,v) subject to Fₙ(u,v)>ε (10)
where n is the n^{th} step of iteration

Categorization of Intersection Points (Entry or Exit)

Once the intersection points are found for every ray that is cast onto the slice planes, these points are classified as an entry or an exit point in step 326. The CAD workstation system 16 may perform this by calculating the normal of the surface at the point under consideration. The normal vector can be calculated by the cross product of the tangent vectors in the u and v direction evaluated at the point given respectively by equations (11) and (12) as

$$\begin{matrix}{T}_{u} = \frac{δ}{δ u} S ( u , v ) & ( 11 ) \\ {T}_{v} = \frac{δ}{δ v} S ( u , v ) & ( 12 )\end{matrix}$$

The normal vector at this point is then given by
\overline{N}=Tᵤ×Tᵥ (13)

If it is assumed that the ray shoots across in the y direction, then a point is classified to be: an entry point If N_{y}<0; an exit point if N_{y}>0; and an edge point if N_{y}=0. The points once classified are stored in a predefined format to be displayed on screen and for conversion to machine instructions.

Implementation and Case Study Examples

The algorithms may for example, be implemented in C++. Application of these algorithms to a variety of model shapes including simple NURBS surfaces, as well as complex curved NURBS surfaces provide three test cases, described below. FIG. 3 gives the generalized algorithm for ray-casting of NURBS surfaces that includes all of the steps outlined above.

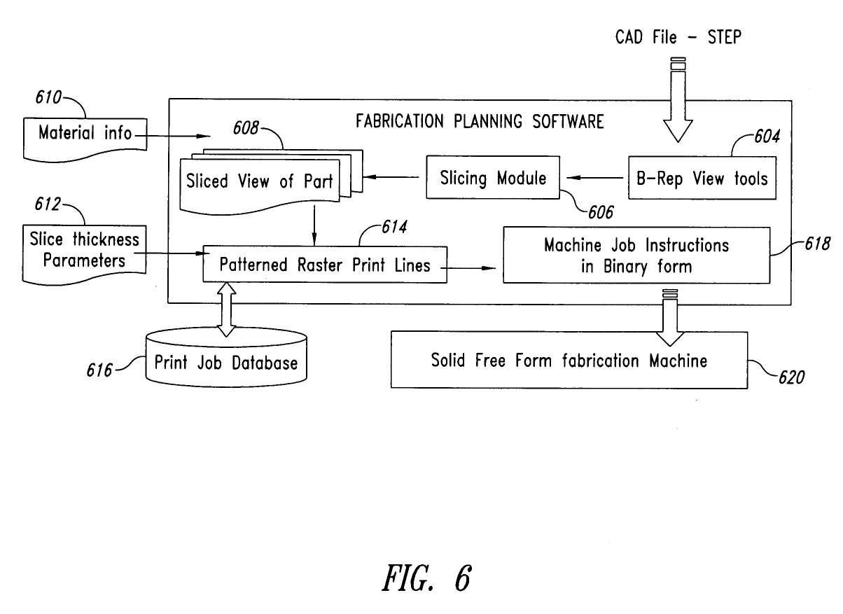

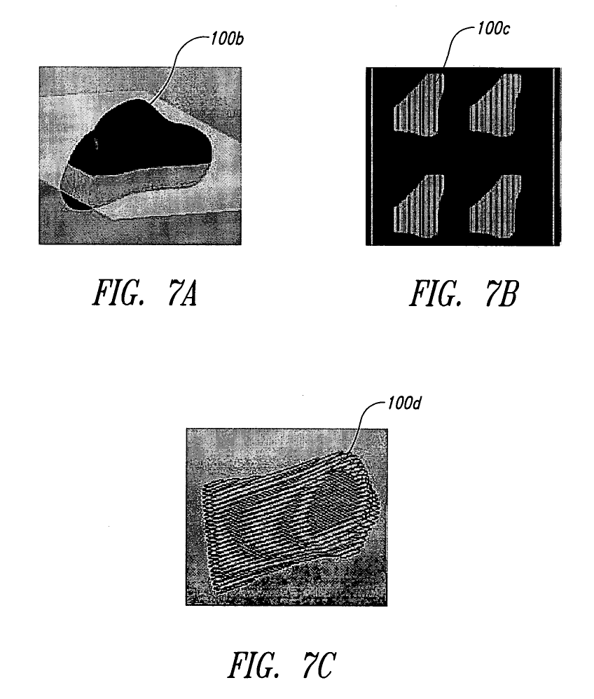

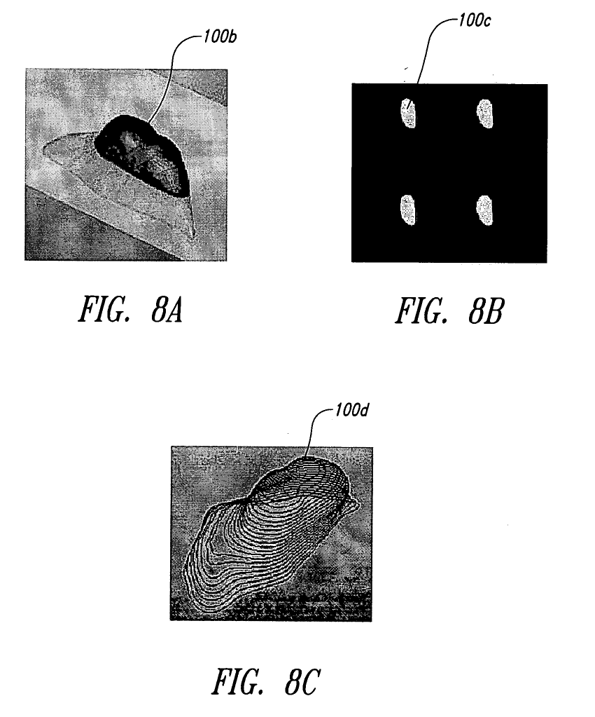

FIG. 6 details the data process planning algorithm 600 from the CAD file input stage to that of the final fabrication stage. For heterogeneous models, intersections of a ray to each geometric body are calculated in sequence. Thus the material associated with the geometric body being sliced can be captured and stored in the slicing data structure.

In step 602, the CAD workstation 16 receives a CAD file, for example, in STEP format. In step 604, the CAD workstation 16 operates on the CAD file using B-rep view tools. The CAD workstation 16 slices the resulting data using a slicing module (e.g., above described algorithm embodied in software) in step 606. The result is a number of sliced views of the part 608, which may incorporate specific material information 610. The CAD workstation 16 may employ slice thickness parameters 612 to create patterned raster print lines 614 for the sliced views 608, which may be stored and/or retrieved a print job database 616. The CAD workstation 16 then creates machine job binary instructions 618 to drive a solid free form fabrication machine 620.

All the models in the below examples were sliced at a constant layer thickness with constant ray offsets on the slice plane.

Model 1: This model 100 is relatively small with about 16 NURBS surface definitions and was extracted from the STEP input CAD file using a STEP reader. A subdivision factor of 0.01 and a tolerance value of 0.01 were used for adaptive refinement and root finding respectively. FIG. 7A shows the model 100b optimally oriented with the least height in the z-direction. FIG. 7B shows a slice layout 100c on the fabrication bed at the slice position defined by the slice plane as shown in FIG. 7A. FIG. 7C illustrates the model 100d showing a number of entry and exit points.

Model 2: The second model contained 102 NURBS surface definitions, extracted through the same method using the reader and the data transferred to the algorithm. In this case a subdivision factor of 0.1 was sufficient for appropriate slicing with no perceivable slice errors during part layout. The same tolerance value of 0.01 was used for the root finding routine. FIG. 8A shows the model 100b optimally oriented, FIG. 8B illustrates the sliced model part layout 100c and FIG. 8C illustrates the model 100d showing a number of entry and exit points.

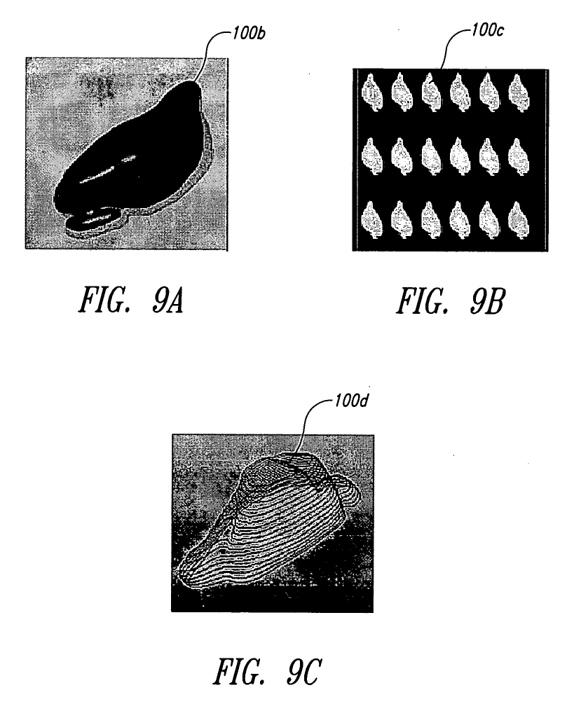

Model 3: The third model is more complex not only in terms of having more number of NURBS surface but also in terms of its overall shape. This model depicts the capability of the algorithm to handle multiple exit, entry points as well as accurate slicing at edges of the model. A subdivision factor of 0.1 and a tolerance value of 0.01 was used for the process. FIG. 9A illustrates the model 100b, FIG. 9B illustrates the corresponding slice layout 100c on the fabrication bed and FIG. 9C illustrates the model 100d showing a number of entry and exit points. It can be seen that the model was sliced appropriately with key features detected at the slice plane shown.

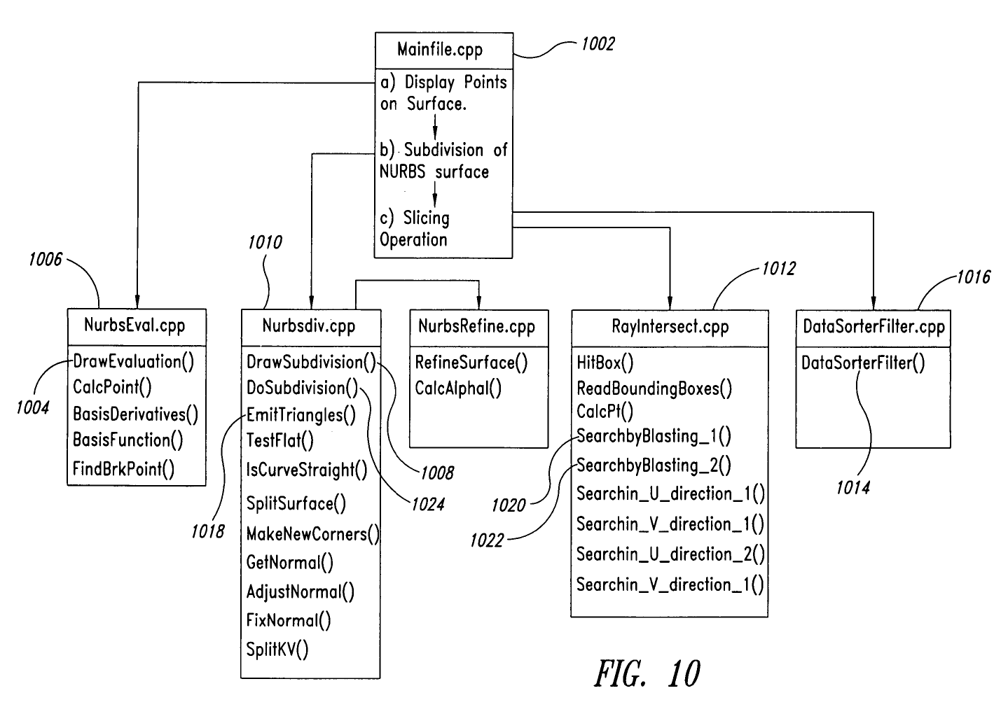

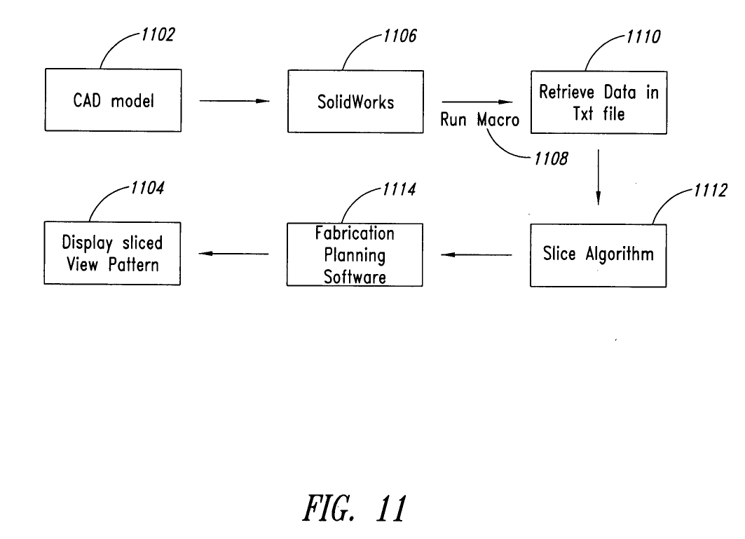

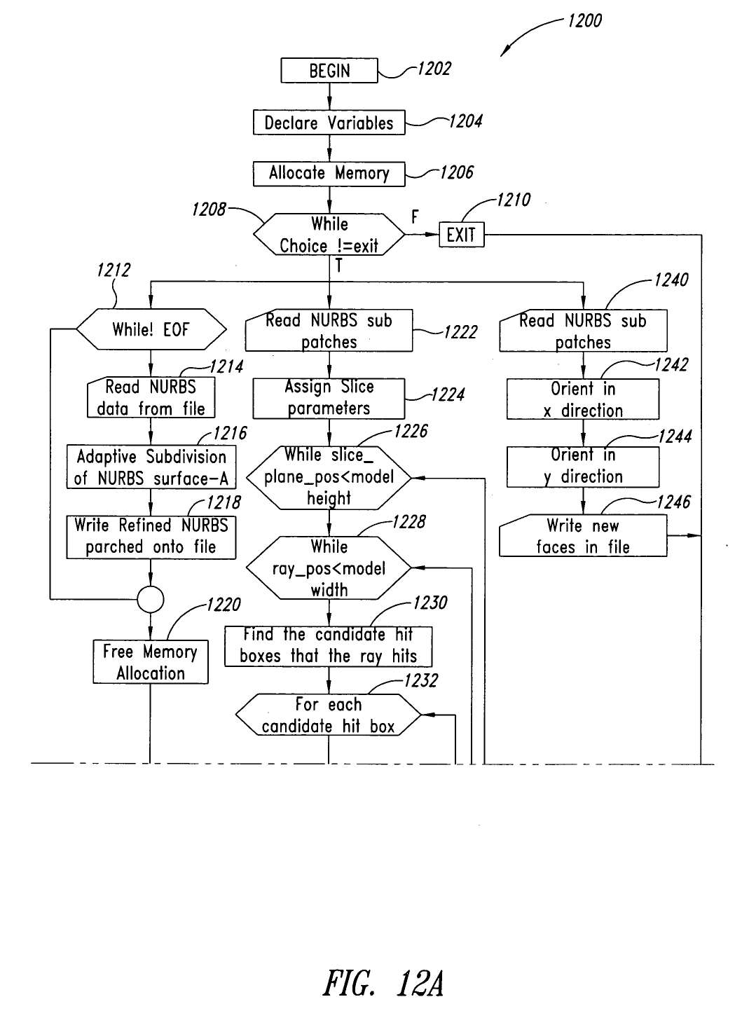

FIG. 10 shows how a slice algorithm code may be implemented in C programming language under the Microsoft Visual Studio compiler environment according to one illustrated embodiment. The different modules of the algorithm may be implemented as separate files or routines and all of the files linked together by the main file or routine, collectively referred to herein as the slicing module. In particular, FIG. 10 shows an number of exemplary functional subroutines available in each file or routine. The functionalities of each file, and flowcharts for each of the major routines within the files are discussed in more detail below.

A main file or routine (Mainfile.ccp) 1002 contains the main ( ) function of the slicing module. The main file or routine 1002 may implement an interactive menu system with user selectable options, for example, three options. The first option available is the ability to cover the NURBS model with a point cover. This option can be selected to evaluate the accuracy in initial data input to prevent unforeseen errors during the slicing operation. The procedure calls up a function DrawEvaluation( ) 1004 from a file NURBs Evaluation file 1006 (NurbsEval.cpp). The second option in the menu is the ability to subdivide the NURBS surface to smaller sub-patches. This is implemented by calling a function DrawSubdivision( ) 1008, available from a NURBS Division file 1010 (Nurbsdiv.cpp). This is the initial preprocessing step used before the actual slicing operation. The third option available is the actual slicing operation to calculate the intersection points. Function calls are made to different bisection routine methods, defined in a Ray Intersect file 1012 (Rayintersect.cpp). Besides that, a function call to Datasorterfilter( ) 1014 defined in a Data Sort file 1016 (Datasorterfilter.cpp) is made to organize and output the calculated intersection points in the required format.

The NURBS Evaluation file 1006 includes procedures that produce a uniform cover of points evenly spaced out on the surface of the NURBS CAD model. The number of surface points generated can however be controlled by assigning different values to the variable “Granularity.” The default value may be set to 100. The function evaluates the surface points at specific values of knot parameters u and v by iterating through the parameter values, the surface points are generated.

The NURBS Division file 1010 contains the procedures that perform the task of subdividing the original NURBS data to smaller sub patches. An adaptive subdivision procedure of the surface takes place and continues until it meets the subdivision criteria factor given by the variable “SubdivTolerance.” The value may range, for example, from 0.1 to 0.01, depending on the size of the model and complexity in its outer contour surface. The lower the tolerance value, the greater the number of subdivisions with subsequently higher number of sub patches. Care should be taken in selecting this value is needed and the typical user will gain experience in the appropriate value to be chosen. A procedure EmitTriangles ( ) 1018 saves the output sub-patches in a defined format onto a text file.

The Ray Intersect file 1012 contains all of the functions responsible for the slicing operation. The major functions include reading bounding boxes that contain the sub patches, determination of the bounding box that has been hit by the ray, and bisection iteration routine procedures. The output from these functions are the intersection points and they are sent to the main file 1002 using a variable pointer “hitpoint.” There are four bisection routines in all, each with a different characteristic in searching for the intersection points. Not all routines are called and each new bisection routine is called only if the function above them fails to find the intersection point. If all four of the bisection routines functions fail to find any point, then two other functions (i.e., Search_by_Blasting_{—}1 function 1020, Search_by_Blasting_2 1022) are activated. These functions implement time consuming procedures, where the small sub patch of the NURBS surface is flooded with large number of points. The functions then find the point that satisfies the intersection point criteria. The difference between the Search_by_Blasting_{—}1 function 1020 and the Search_by_Blasting_{—}1 function 1022 is that one has a more relaxed condition of success criteria than the other. If none of the six functions are able to find an intersection point, a NULL value is returned to the main program 1002 signifying a NO HIT status for the ray.

All intersection points that are returned to the main program 1002 by the Ray Intersection file 1012 for one slice level are stored within an output data structure. The data structure is sent to the datasorterfilter( ) function 1014 contained within the Data Sort file 1016. The collection of points is then filtered according to a set of conditions, in order to classify the points as Entry or Exit Points. The conditions are based on a number of factors that include direction of normal, magnitude of normal, condition of Hit etc. Once the data is filtered, the points are written out, in a format readable by the Fabrication Planning software with appropriate points marked as Entry or Exit.

FIG. 11 gives the overall implementation from the CAD model 1102 to the raster display 1104 of the different slices. The slicing module integrates within a complete framework in which CAD data is first acquired through the CAD vendor Solidworks 1106. A Macro 1108 is executed to acquire the NURBS data of the CAD model from the solid modeling kernel, and it is output in a predefined text format 1110. This input file is read by the slicing module 1112 and appropriate process planning instructions are generated. These instructions in the form of a specified output are read by the Fabrication Planning Software 1114 to display the raster pattern 1104 of the slice layers that make up the model.

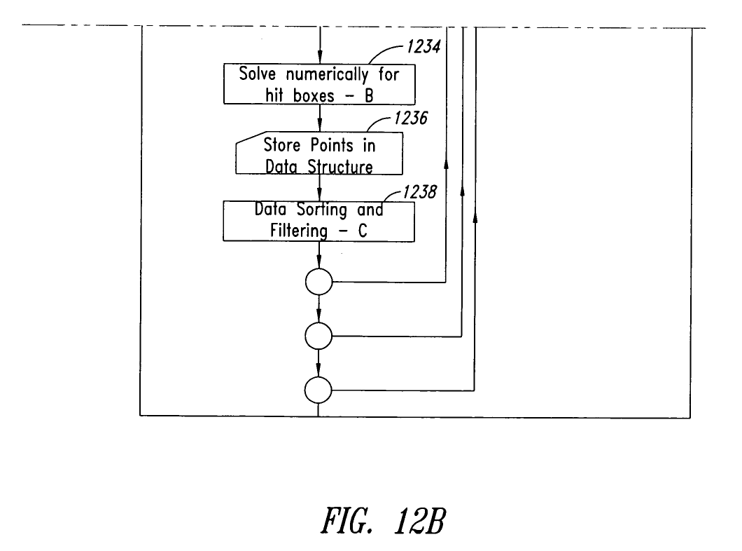

FIGS. 12A and 12B show a method 1200 of implementing the main file or routine 1002 (FIG. 10), according to one illustrated embodiment. The method 1200 starts at 1202, and variables are declared at 1204. Memory is allocated at 1206. At 1208, a processor executing the method determines whether a user has made a user selection to exit the method 1200. If so, the method 1200 exits at 1210.

At 1212, the processor determines whether the end of file (EOF) has been reached for the subject file. Until the EOF is reached the processor successively reads NURBS data from a file at 1214, performs adaptive subdivision of the NURBS surface definitions at 1216; and writes refined NURBS definitions onto the subject file at 1218. The processor frees memory allocation at 1220 upon reaching the EOF.

At 1222, the processor reads NURBS subpatches. At 1224, slice parameters are assigned. At 1226, the processor enters an outer while loop, which is executed while the position of the slice plane is less than the height of the model. At 1228, the processor enters an inner while loop, which is executed while the ray position is less than the width of the model. Within the nested while loops 1226, 1228, the processor at 1230 finds the candidate hit boxes that the ray hits or intersects. At 1232, the processor enters a loop for each candidate hit box, in which the processor solves numerically for hit boxes at 1234, stores points in a data structure at 1236, and sorts and filters data at 1238.

At 1240, the processor reads NURBS subpatches. At 1242, the processor orients the model in the X direction, and at 1244 orients the model in the Y direction. At 1246, the processor writes new faces in the file.

FIG. 13 shows a method 1300 of performing the NURB Division file or routine 1010 (FIG. 10) according to one illustrated embodiment.

The method 1300 starts at 1302. At 1304, the variables are initialized, being set to false. At 1306, the four corners of the surface are initialized by their respective normals. A call to a DoSubdivsion procedure is made at 1308. The method 1300 terminates at 1310.

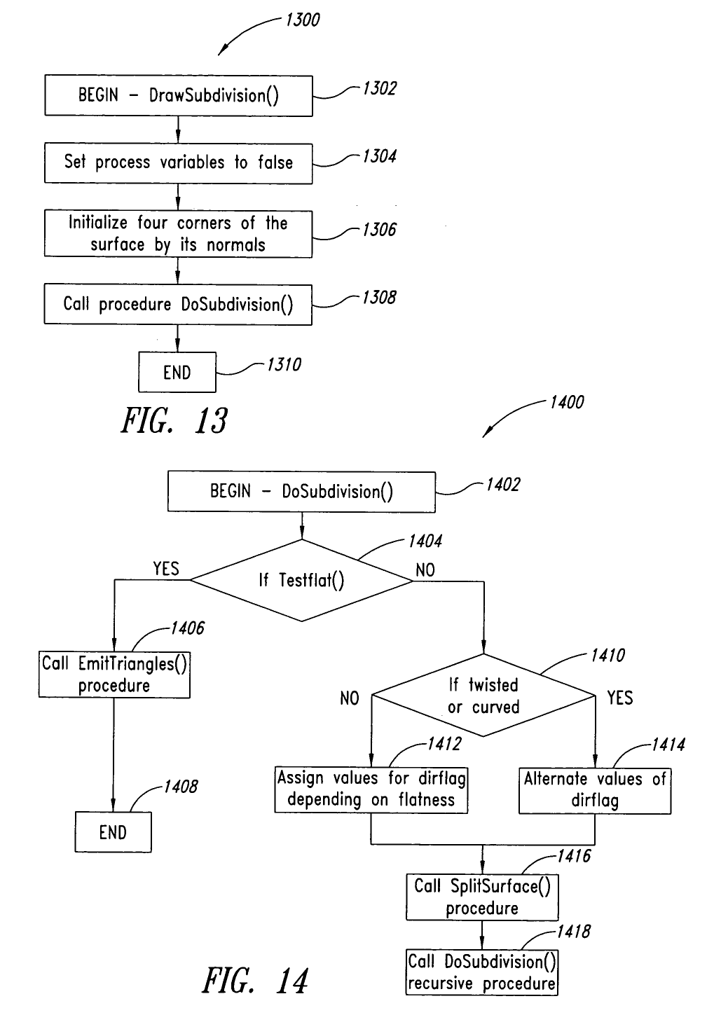

FIG. 14 shows a method 1400 of implementing the DoSubdivsion procedure 1024 (FIG. 10) called at 1308 (FIG. 13) of the method 1300. The method 1400 starts at 1402. At 1404, the processor determines whether the surface is flat. If the surface is flat, at 1406 the processor calls the emit triangles procedure 1018 (FIG. 10), and terminates at 1408 on return from the emit triangles procedure 1018.

If the surface is not flat, the process determines if the surface is twisted or curved at 1410. If the surface is not twisted or curved, the process at 1412 assigns values to direction flag variable depending on the flatness of the surface. Otherwise, at 1414 the processor assigns alternative values to the direction flag variable. At 1416, the processor calls a surface splitting procedure (i.e., SplitSurface( )), and at 1418 recursively calls the itself.

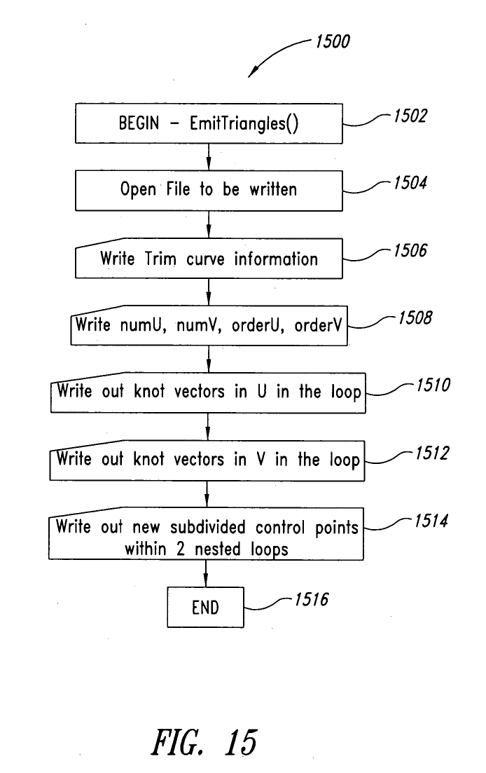

FIG. 15 shows a method 1500 of implementing the emit triangles file or routine according to one illustrated embodiment, starting at 1502. At 1504, the processor opens the file to be written. At 1506, the processor writes trim curve information to the file. At 1508, the processor writes parameters numU, numV, orderU and orderV to the file. At 1510, the processor writes the knot vectors U in the respective one of the nested loops, and at 1512 writes the knot vectors V the respective one of the nested loops. At 1514, the processor writes new subdivided control points with the two nested loops, terminating at 1516.

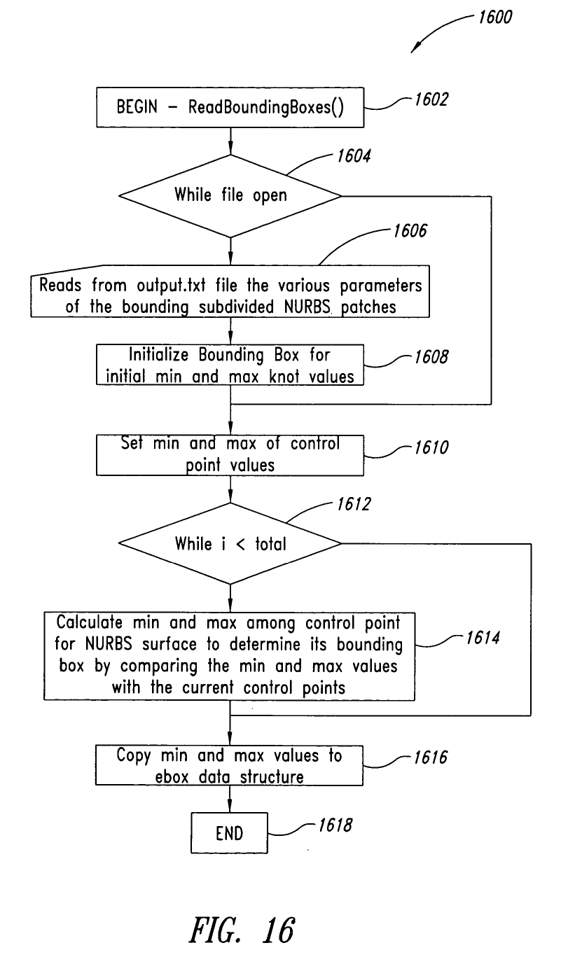

FIG. 16 shows a method 1600 of the Read Bounding Boxes file or routine according to one illustrated embodiment, the method 1600 starting at 1602. At 1604, the processor executing the method 1600 beings a first while loop. While the file is open, the processor at 1606 reads various parameters of the bounding subdivided NURBS patches from the output text file, and at 1608 initializes the bounding box for initial minimum and maximum knot values.

At 1610, the processor sets the minimum and maximum for he control point values.

At 1612, the processor begins a second while loop. While an integer i is less than a total, the processor calculates minimum and maximum values among the control points for the NURBS surfaces at 1614, in order to determine the bounding box by comparing the minimum and maximum values with the current control points.

At 1616, the processor copies the minimum and maximum values to a data structure (ebox). The method 1600 terminates at 1618.

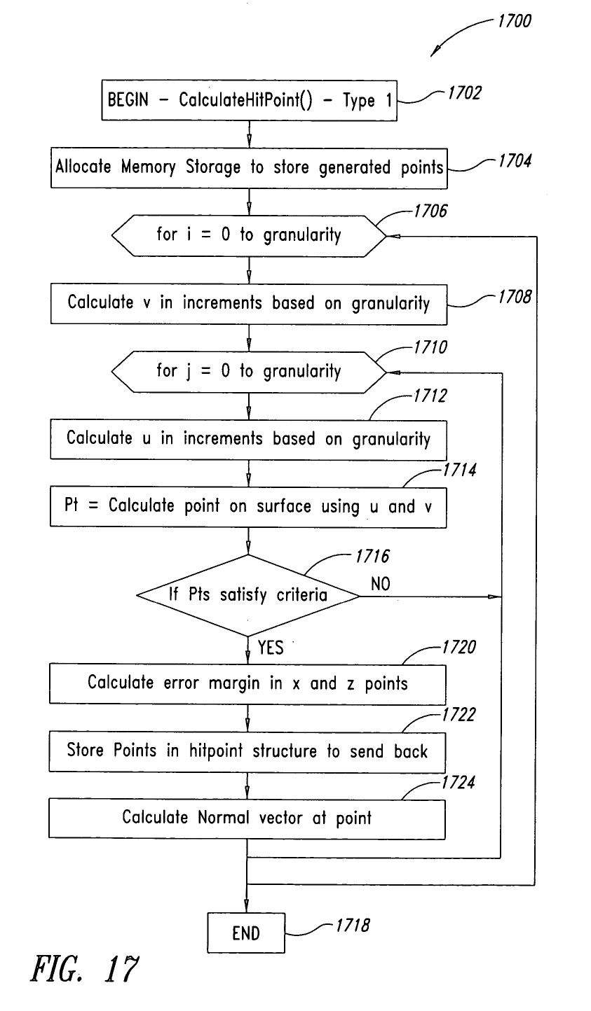

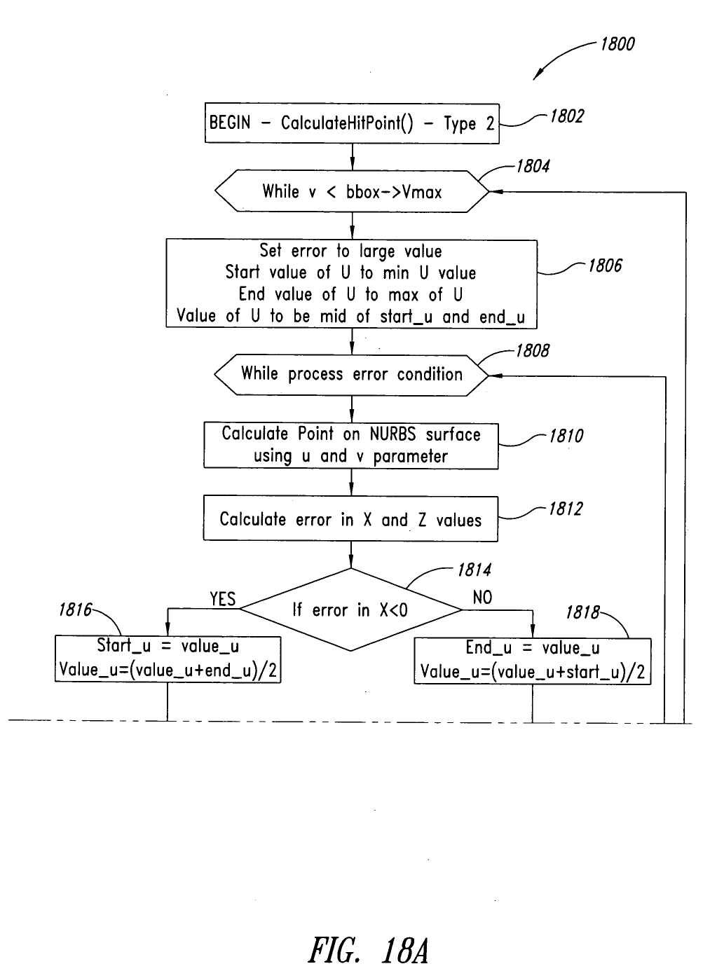

FIG. 17 shows a method 1700 of implementing a Calculate Hit Point file or routine according to one illustrated embodiment, the method 1700 starting at 1702.

At 1704, the processor executing the method 1700 allocates memory to store points to be generated by the method 1700.

At 1706, the processor executes an outer “for” loop, incrementing an integer i from zero to a granularity setting. At 1708, the processor incrementally calculates a variable v based on the granularity.

At 1710, the processor executes an inner “for” loop, incrementing an integer j from zero to the granularity setting. At 1712, the processor incrementally calculates a variable u based on the granularity. At 1714, the processor determines a point on the surface using the calculated variables v and u. At 1716, the processor determines whether the determined points satisfy the defined criteria. If the determined points do not satisfy the defined criteria, the method 1700 terminates at 1718. Otherwise, the processor at 1720 determines an error margin in the X and Z points. At 1722, the processor stores the points in a hit point data structure. At 1724, the processor calculates a normal vector at the point.

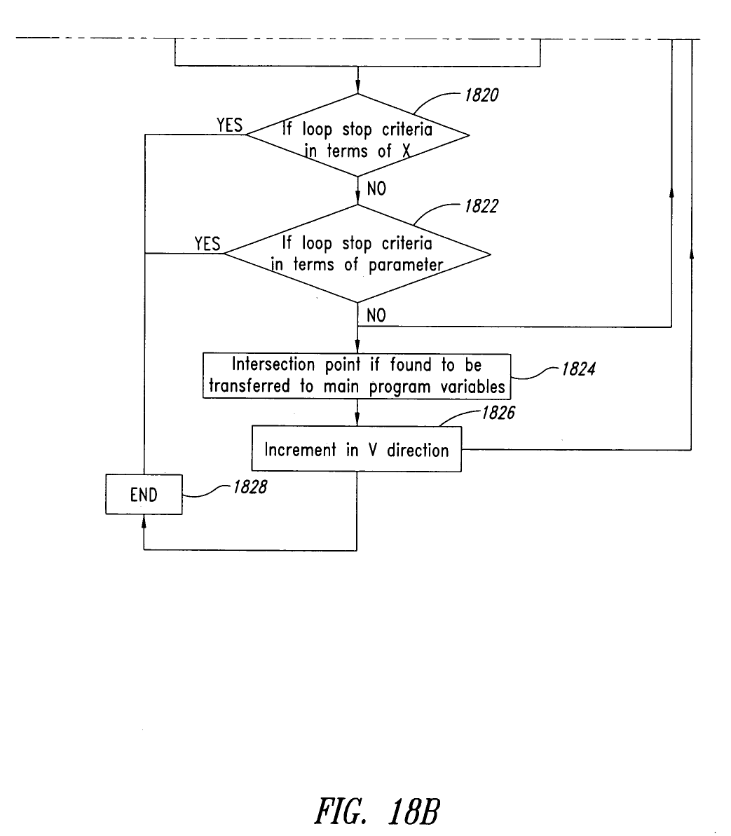

FIGS. 18A and 18B show a flow diagram 1800 of a Calculate Hit Point file or routine according to another illustrated embodiment, the method 1800 starting at 1802.

The processor executing the method 1800 executes a while loop at 1804, while a variable bbox is between the value v and Vmax. At 1806, the processor sets an error variable to a large value and sets a start value of the variable U (start_U) equal to the minimum U value. At 1806, the processor also sets an end value of the variable U (end_U) equal to the maximum U value, and sets the value of U between the start and end values of U.

At 1808, the processor executes a while loop. At 1810, the processor determines a point on the NURBS surface using the u and v parameters. At 1812, the processor determines an error in both X and Z values.

At 1814, the processor determines if the error in the X value is less than zero. If the error in the X value is less than zero, the processor at 1816 sets the start value of U equal to the value of U, and sets the value of U equal to the quotient of the sum of the value of U plus the end value of U, divided by two. If the error in the X value is not less than zero, the processor at 1818 sets the end value of U equal to the value of U, and sets the value of U equal to the quotient of the sum of the value of U plus the start value of U, divided by two.

At 1820, the processor executes a outer nested if loop, and at 1822 executes an inner nested if loop. At 1824, the processor transfers any found intersection point to the main program variables. At 1826, the processor increments in the V direction. The method 1800 terminates at 1828.

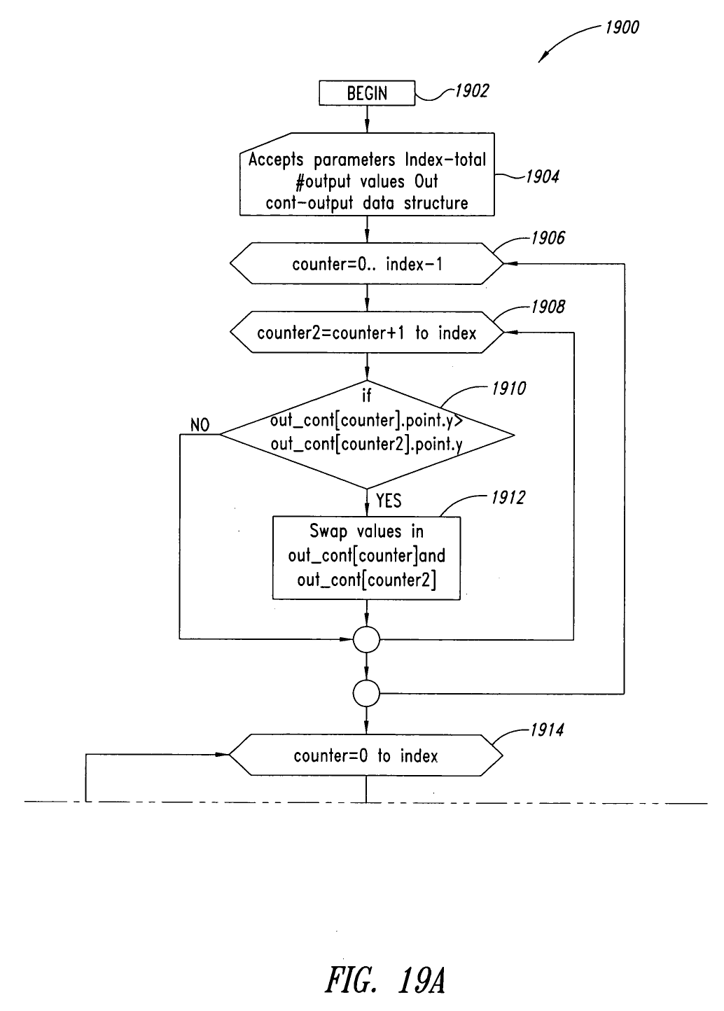

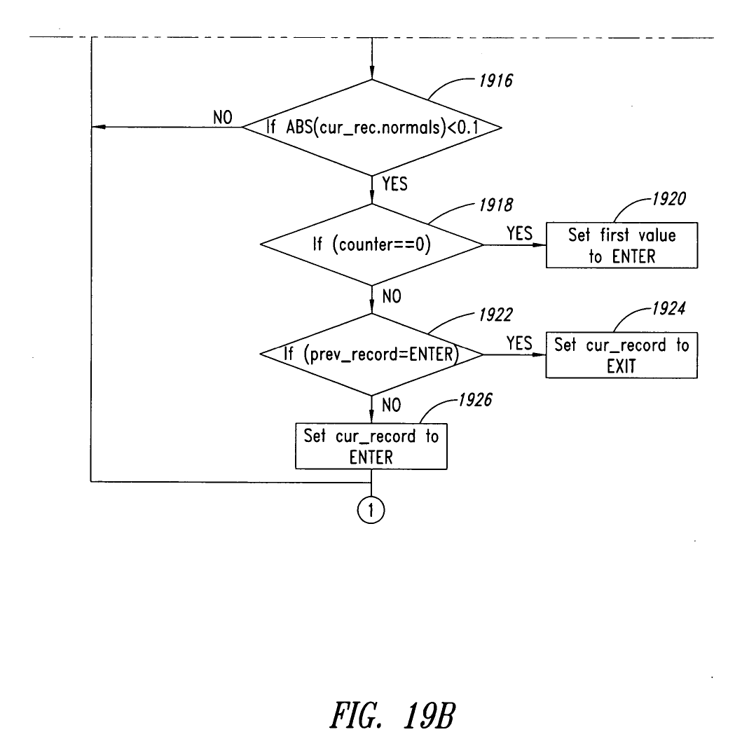

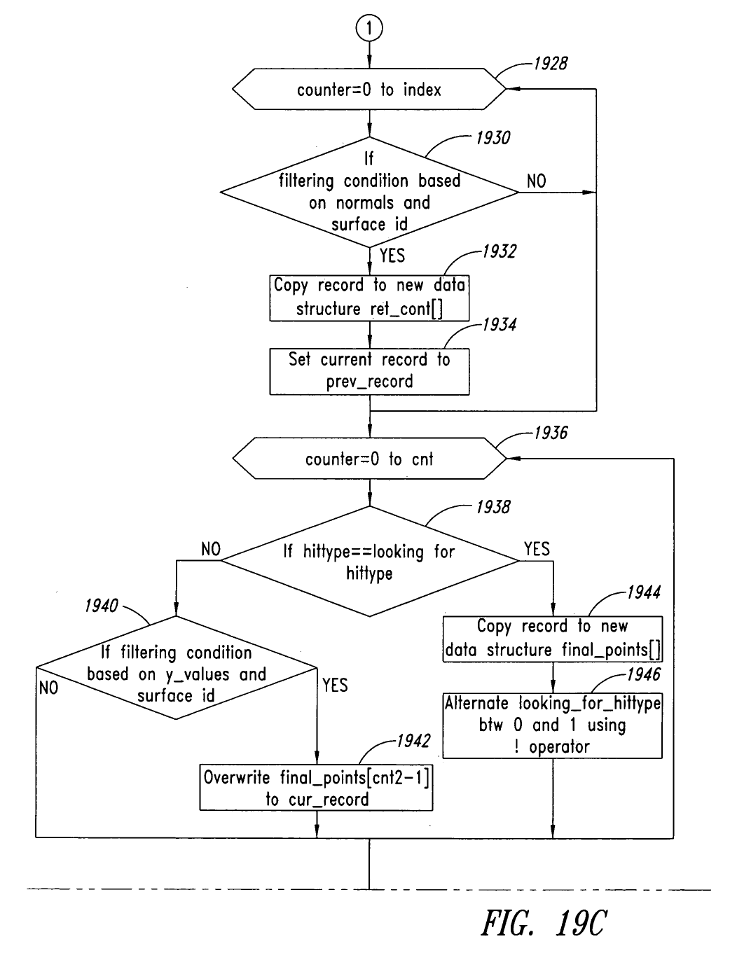

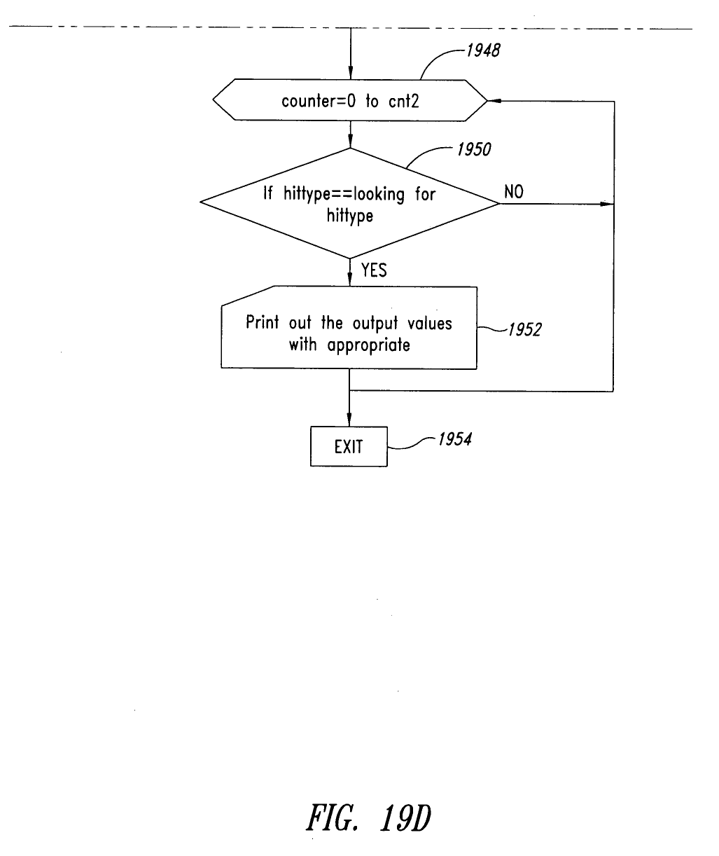

FIGS. 19A-19D show a method 1900 of implementing the Data Sort file or routine according to one illustrated embodiment, the method 1900 starting at 1902.

At 1904, the processor executing the method 1900 accepts parameter values, sets an index value to the total number of output values and initializes an array Out_cont using the data stored in the output data structure. At 1906, the processor executes a first counter loop that increments a first counter value from zero to the index value minus one. At 1908, the processor executes a second counter loop that increments a second counter value from the first counter value plus one to the index value.

At 1910, the processor determines if the value stored in the array Out_cont at an position equal to the first counter variable for a point Y is greater than the value of the value stored in the array Out_cont at a position equal to the second counter variable. If the value greater, the processor at 1912 swaps values between positions in the array Out_cont.

At 1914, the processor executes another counter loop, incrementing the first counter between zero and the index value. At 1916, the processor determines whether the absolute value of current normal is less than 0.1. If not, the counter loop continues. If so, the processor determines if the first counter is equal to zero at 1918. If the first counter is equal to zero, the processor set a first value to enter at 1920. If the first counter is not equal to zero, the processor determines in the previous record is equal to enter at 1922. If the previous record is equal to enter, the processor sets the current record equal to exit at 1924, and if not the processor sets the current record equal to enter at 1926.

At 1928, the processor executes another counter loop, incrementing the first counter from zero to the index value. At 1930, the processor determines if of the filtering condition bases on the normals and surface identity. If not, the counter loop increments. If so, the processor copies the record to a new data structure ret_cont( ) at 1932. The processor then sets the current record equal to the previous record at 1934.

At 1938, the processor determines whether the hit corresponds a desired type of hit. If not, the processor determines if the filtering condition based on Y-values and the surface identity at 1940, and overwrites the final points array at position given by the second count value minus one to the current record at 1942. If so, the processor copies the record to the new data structure final points ( ) at 1944, and performs alternating looking for the hit type between the values of zero and one at 1946.

At 1948, the processor executes a further counter loop, increment the first count between zero and the second count value. At 1950, the processor determines if the hit type matches the desired hit type, incrementing the first counter if not. If the hit type does equal the desired hit type, the processor prints out the output values at 1952, and terminates the method 1900 at 1954.

The above algorithms are implemented in software, and tested for 10 different kinds of models each with certain characteristics of its own to test the capability of the algorithm. Given below is the test case results and its various process parameters. With respect to Model #1, a detailed explanation is include describing how to run the algorithm from the initial CAD input to final raster display. In other embodiments, the output may be used to drive a manufacturing device, for example, a three-dimensional printer.

Model #1—Sphere

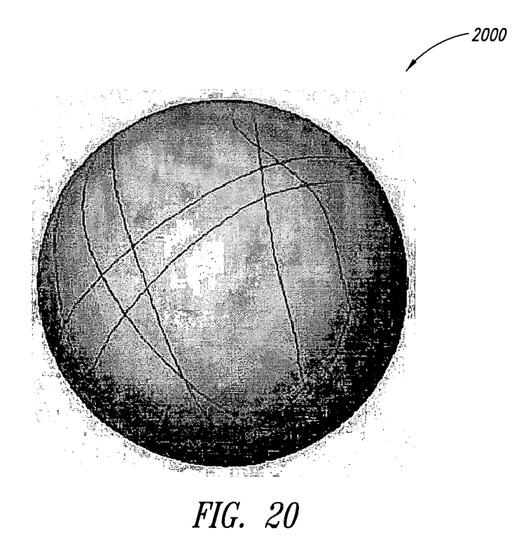

FIG. 20 shows a model 2000 of sphere, perhaps the highest curvature surface with which to test the algorithm's capability to slice with accuracy and quality. The model 2000 of the sphere is composed of 14 NURBS surfaces. A act-by-act procedure is set out below.

Act 1: Open the “.STP” CAD model file in SolidWorks®. Open up Tools->Macro->Run->Splsurf.swp. The macro should take only a few seconds to run. Browse to the directory that contains the Macro and a file named “FACES.txt” should be visible. FIG. 21 shows how the user interface 2100 may appear when the txt file is opened up and viewed. The first Number indicates the total number of NURBS definitions within the file. The second number below gives the Surface ID# of the NURBS definition that follows beneath. The third number gives the number of trimming curves associated with the model. The fourth line contains 2 numbers both indicating the number of control points in the U and V direction. For example, the number 6 and 6 suggest a 6×6 matrix of 36 control points defining the surface. The fifth line contains the order of the NURBS surface in the u and v direction. The sixth line describes the knot vector values in U and the seventh line describes the knot vector values in the V direction. The rest set of lines give the coordinate values of the control points along with their weights. This file then forms the input to the Slicing module.

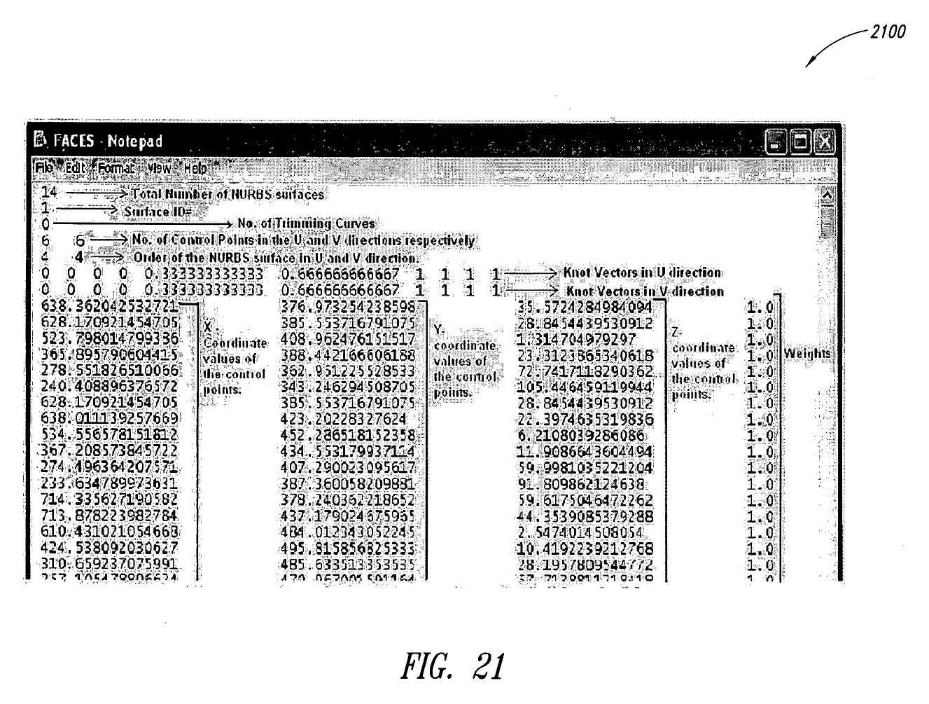

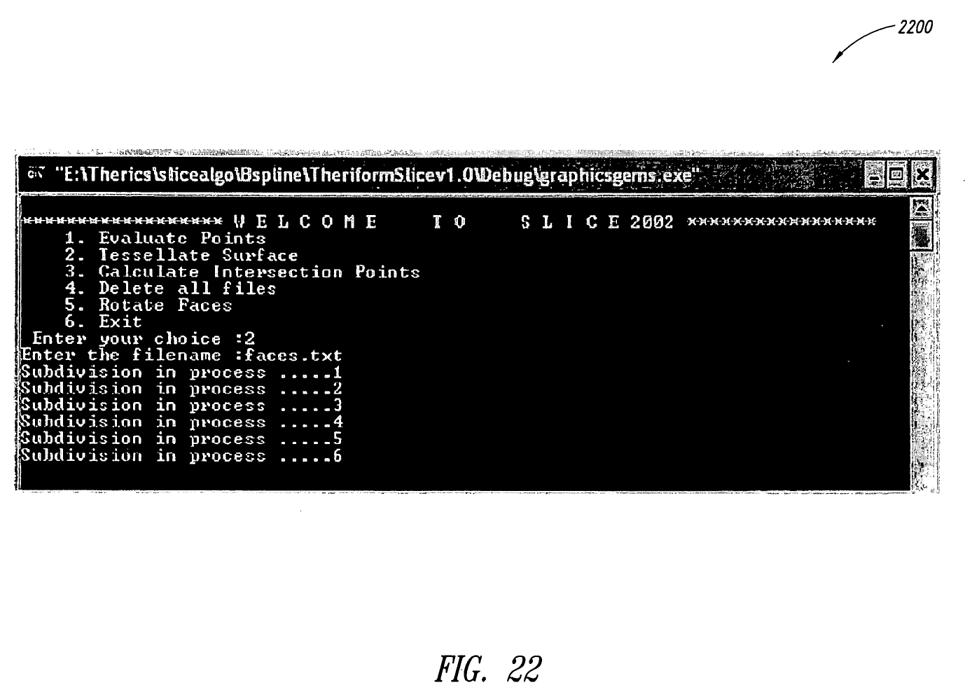

Act 2: Open up the code in Microsoft Visual C++ environment. Compile and Run the code. A menu with different menu choices shows up. The menu has different options and each can be selecting by simply selecting the number of each menu choice. Type in “2” to select Tessellate Surface menu option. The menu then prompts you to enter the Filename that contain the data input; type in “faces.txt”. Once this is done, the code then begins subdividing all of the NURBS surfaces defined in the input file. FIG. 22 shows a captured image 2200 as the algorithm works in subdividing the NURBS surfaces. The subdivided NURBS sub-patches are stored in the file “SubdividedNURBS.txt”

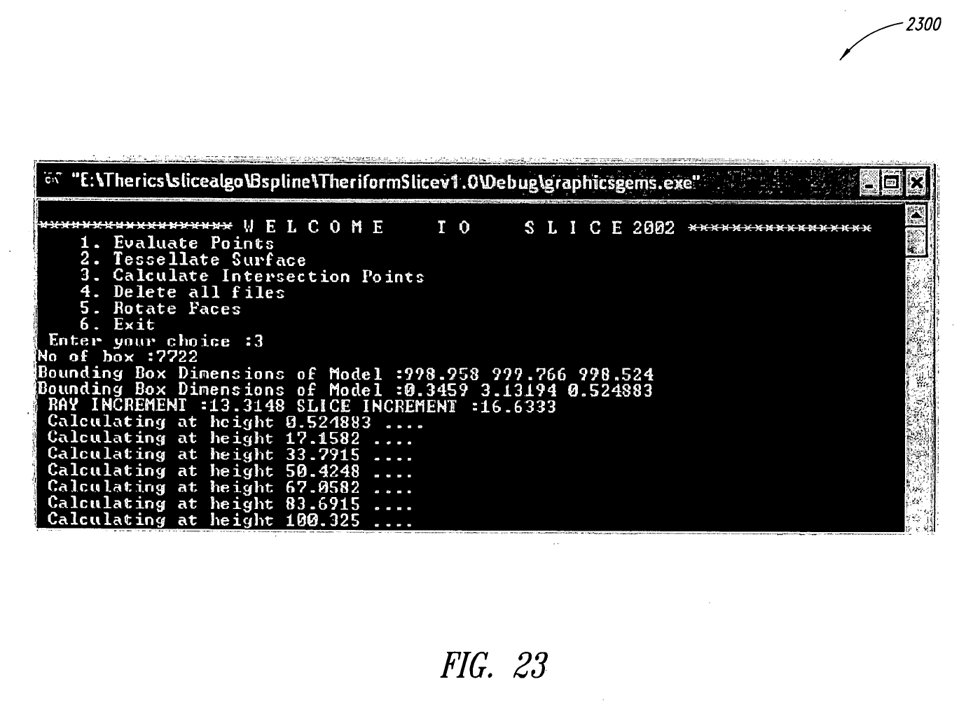

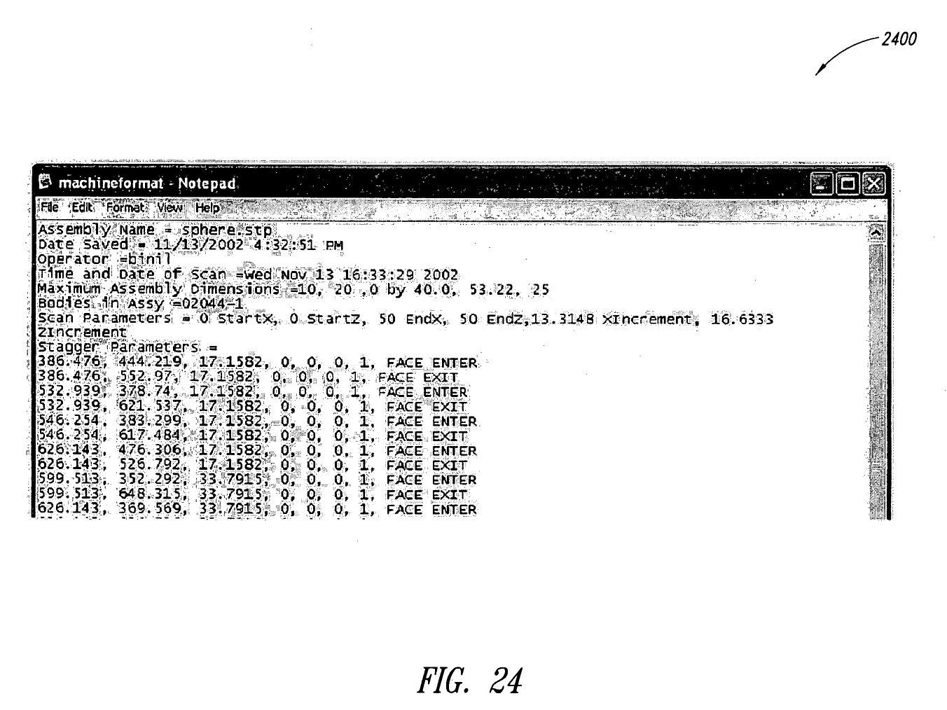

Act 3: After the subdivision process, the menu shows up once again and type in “3” to select the “Calculate Intersection Points” menu option. The procedure opens up the sub-patch file and stores them in data structures. It calculates the Bounding Box dimensions of the model and displays it as shown in the user interface 2300 of FIG. 23. It also displays the total number of NURBS sub-patches, ray increment and slice increment values. The results at the end of this step are stored in the file “machineformat.txt”. The format of this file is shown in the user interface 2400 of FIG. 24. This format allows reading by the Fabrication Planning Software.

FIG. 25A shows the model 2500 of the sphere, and a format box 2502 displaying the process parameters. FIG. 25B shows the raster patterns 2504a-2504d of the sphere as rendered in the Fabrication Planning Software at various slice levels.

Model 2—Cone:

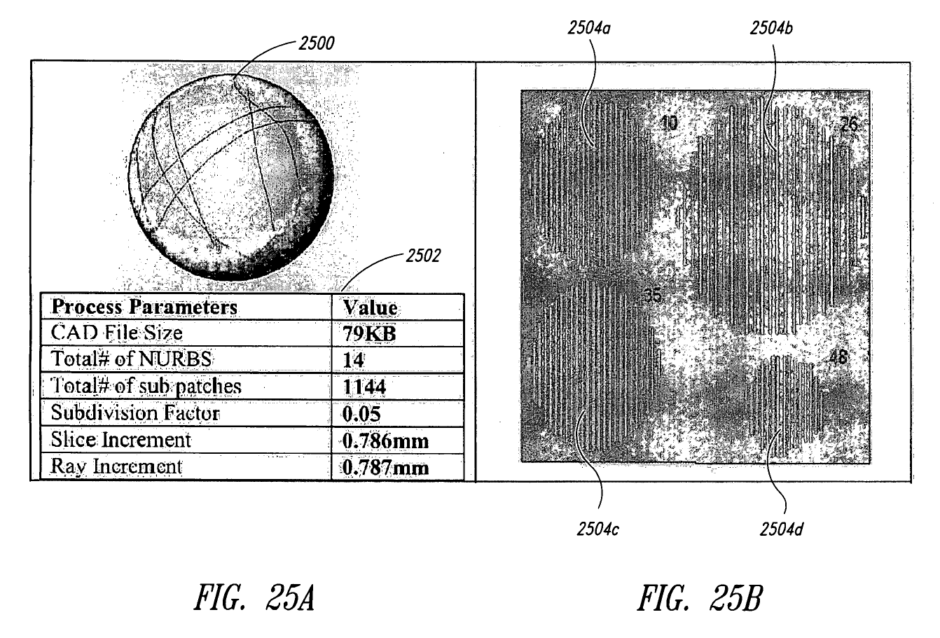

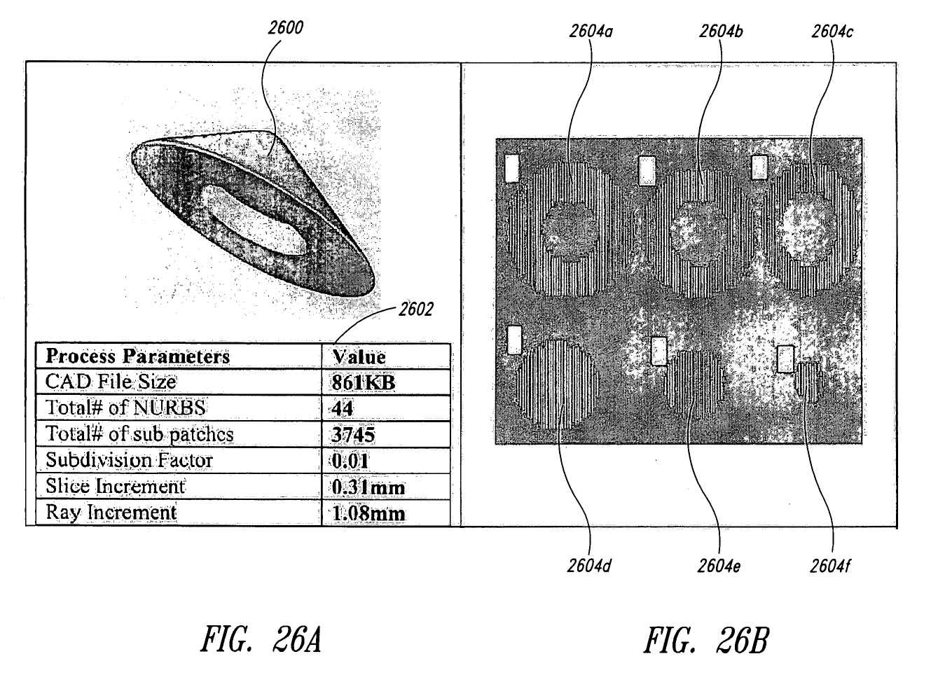

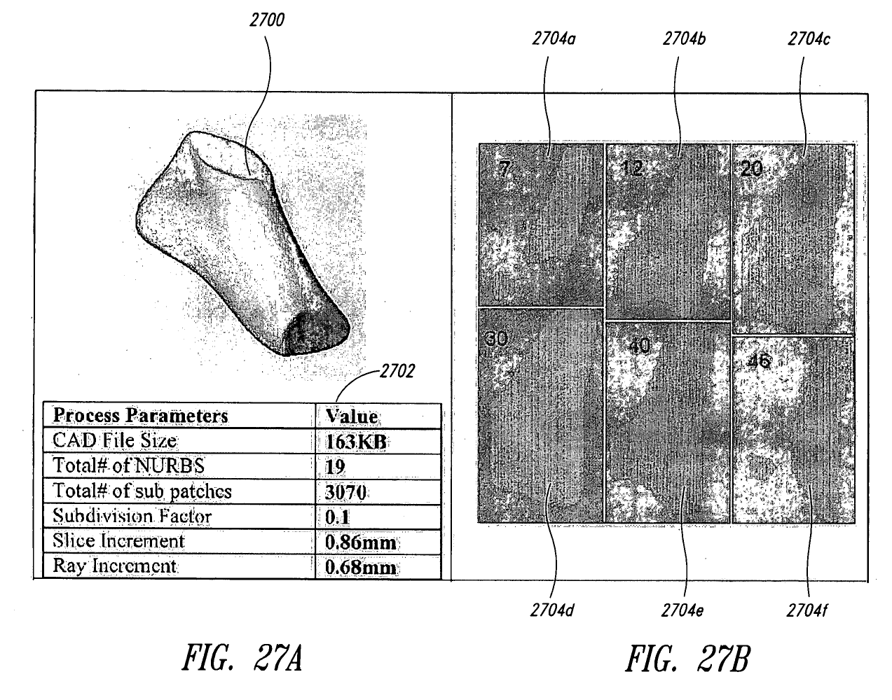

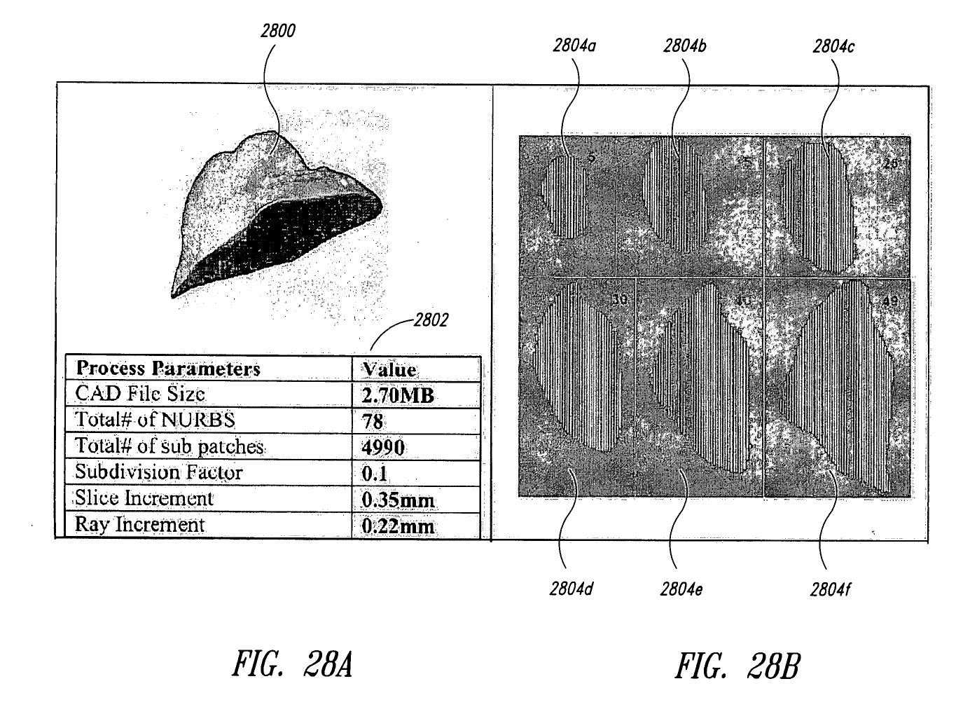

FIG. 26A shows a model cone 2600, consisting of approximately 44 NURBS surface definitions in one exemplary embodiment. The NURBS surface definitions are extracted from a STEP input CAD file using a STEP reader. A subdivision factor of 0.01 and a tolerance value of 0.01 were used for adaptive refinement and root finding respectively, as shown by the format box 2602. The model tests the capability of the algorithm to detect interior cavities as depicted by the hole in the cone at the bottom surface. FIG. 26B shows each of the raster patterns 2604a-2606f at different slice levels. The entry and exit points at every slice layer may also be displayed. The entry and exit points could further be joined to define vectors which can then be used in RP machines that require contour information for fabrication.

Model 3—Foot:

FIG. 27A shows a third model 2700 of a portion of a foot, the third model 2700 extracted through the method using the reader and the data transfer to the algorithm described above. The third model 2700 comprises approximately 19 NURBS surface definitions, as indicated in the format box 2704. The third model 2700 has more complex curved NURBS contours along with multiple entry and exit points than some of the previous models. A subdivision factor of 0.1 is sufficient for appropriate slicing with no perceivable slice errors during part layout. The same tolerance value of 0.01 is used for the root finding routine. FIG. 27B shows the sliced model part layout at different slice levels 2702a-2702f.

Model 4—Sinus Graft: 1

FIG. 28A shows a fourth module 2800 of a first sinus graft, the model 2800 optimally oriented for slicing. The fourth model 2800 complex curved NURBS contours along with multiple entry and exit points. The fourth module may be extracted through the same method using the reader and the data transfer to the algorithm as previously discussed. As illustrated by the format box 2802, a subdivision factor of 0.1 is sufficient for appropriate slicing with no perceivable slice errors during part layout. The same tolerance value of 0.01 is used for the root finding routine. FIG. 28B shows the sliced model part layout at different slice levels 2804a-2804f.

Model 5—Sinus Graft Model 2:

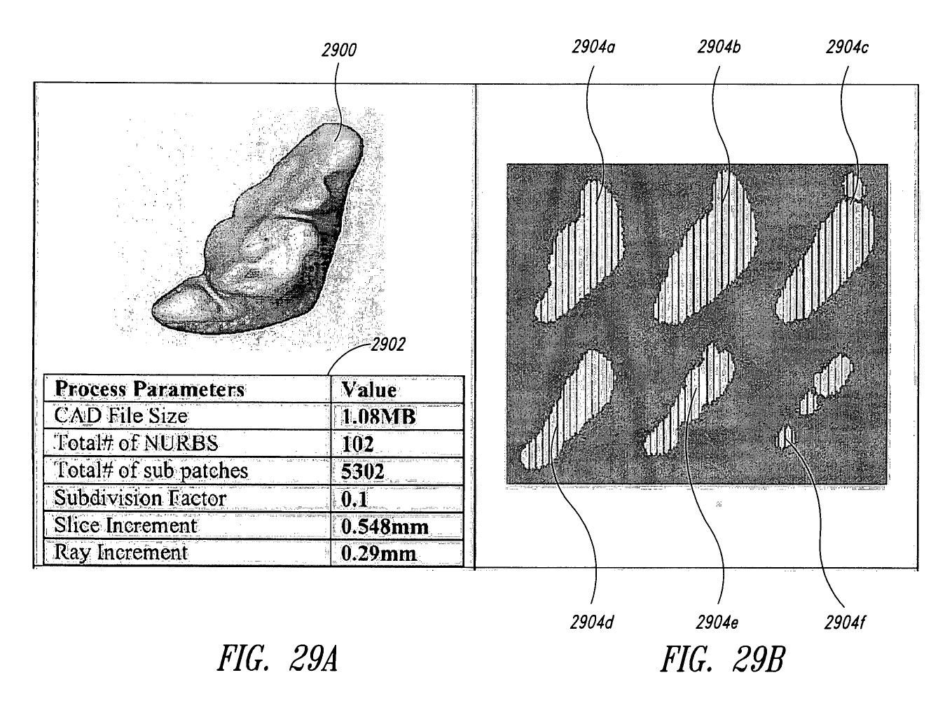

FIG. 29A shows a fifth model 2900 of a second sinus graft, the model 2900 optimally oriented for slicing. The fifth model 2900 comprises complex curved NURBS contours along with multiple entry and exit points. As illustrated by the format box 2902, a subdivision factor of 0.1 is sufficient for appropriate slicing with no perceivable slice errors during part layout. The same tolerance value of 0.01 is used for the root finding routine. FIG. 29B shows the sliced model part layout at different slice levels 2904a-2904f.

Model 6—Sinus Graft Model 3:

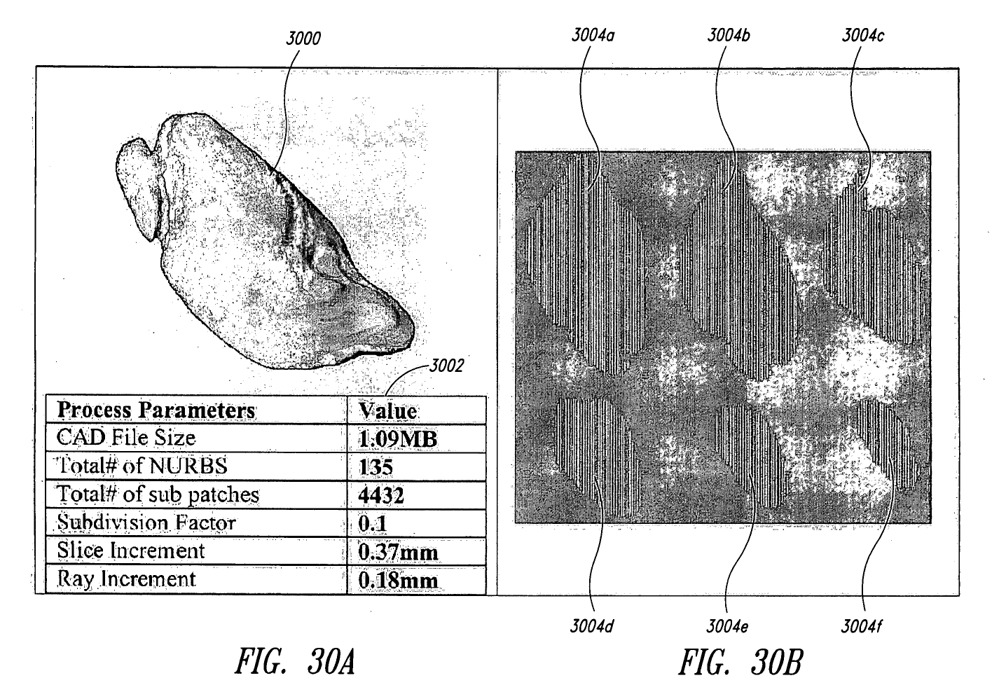

FIG. 30A shows a sixth model 3000 of a third sinus graft, the model 3000 optimally oriented for slicing. The sixth model 3000 is more complex not only in terms of having more number of NURBS surface, but also in terms of its overall shape. The sixth model 3000 illustrates the capability of the algorithm to handle multiple entry and exit points that are close to each other, as well as accurate slicing procedures at tangent edges of the model 3000.

As illustrated by the format box 3002, a subdivision factor of 0.1 and a tolerance value of 0.01 are used for the illustrated process. FIG. 30B shows the corresponding slice layout 3004a-3004f on the fabrication bed for different layers. It can be seen that the algorithm works well with key features detected at the slice plane shown.

Model 7—Sinus Graft Model 4:

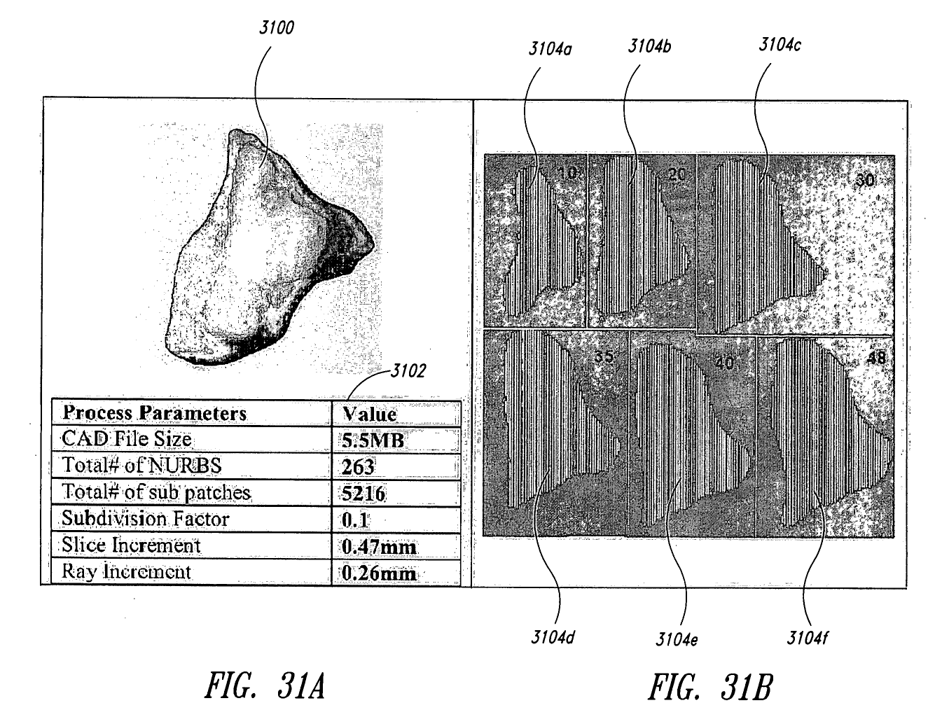

FIG. 31A shows a seventh model 3100 of a third sinus graft, the model 2900 optimally oriented for slicing. The seventh model 3100 comprises a large number of NRUBS surface definitions. As illustrated by the format box 3102, a subdivision factor of 0.1 and a tolerance value of 0.01 are used for the illustrated process. FIG. 31B shows the corresponding slice layout 3104a-3104f on the fabrication bed for different layers.

Model 8—Bone with Holes:

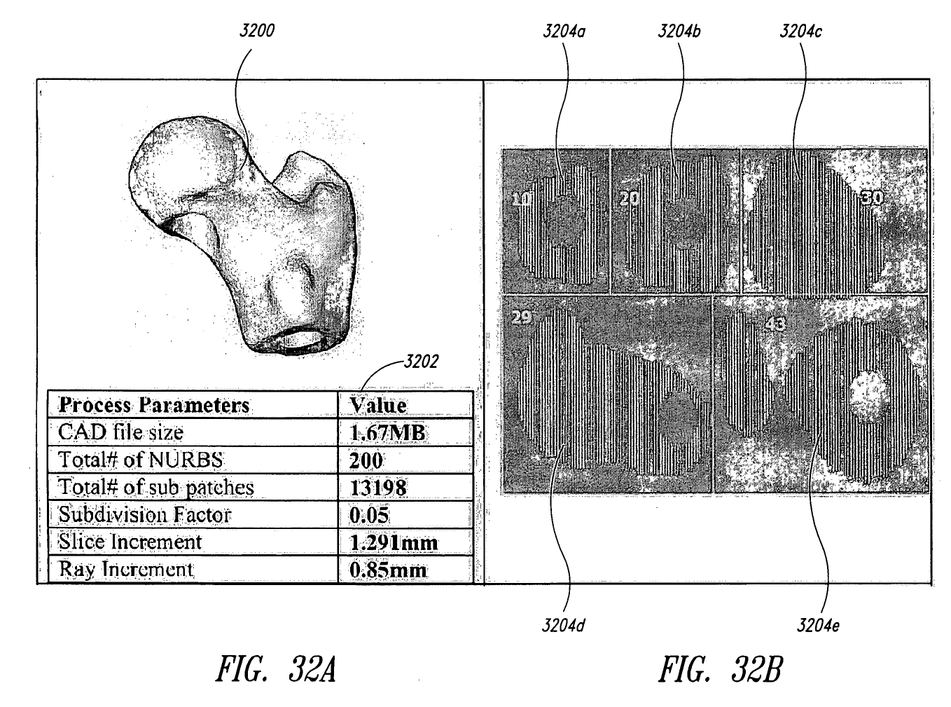

FIG. 32A shows a model 3200 that is not complex in its outer shape, but was selected to determine whether holes drilled within the model 3200 were captured during slicing operation. As illustrated by the format box 3202, the model 3200 has a fairly high number of NURBS surfaces (i.e., 200), with about 13198 sub patches generated by using a sub division factor of 0.05. The model 3200 was fairly long at the z-level hence the slicing algorithm is tested for any memory deficiency issues during the process. FIG. 32B shows the raster patterns 3204a-3204e of the model 3200, and it can be seen that it has fairly captures most interior and exterior detail of the model 3200.

Model 9—Combination Bones:

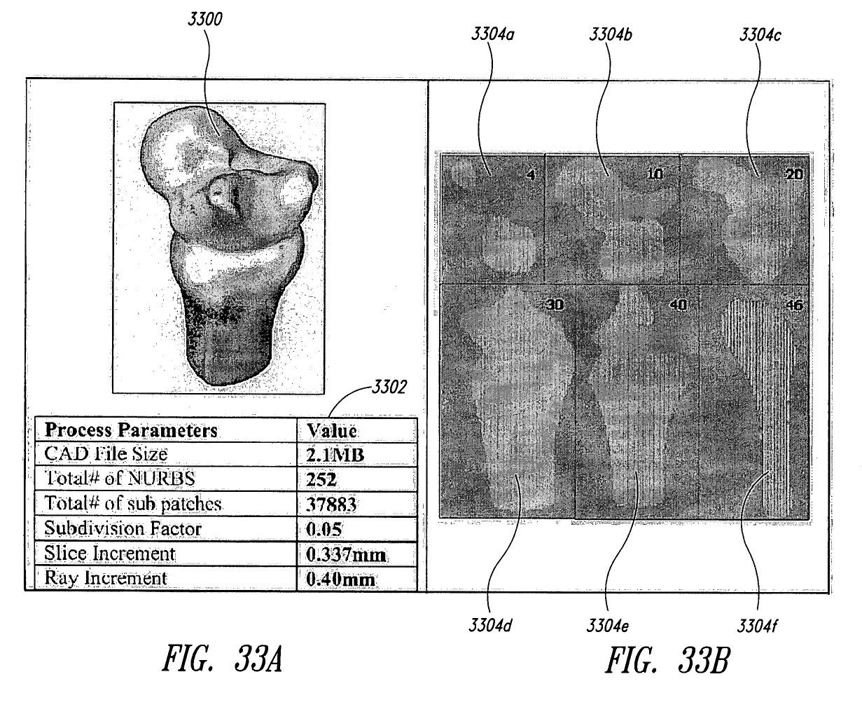

FIG. 33A shows a model 3300 made by combining two complex bone shape architectures and fusing them together to obtain the overall CAD model. The model 3300 has fairly complex contours on its outer shape along with internal hole features. As illustrated by the format box 3302, the model 3100 is comparatively huge with about 252 NURBS surfaces, subdivided with a fairly low subdivision factor at 0.05. This value was used to obtain good results in the raster patterns. FIG. 33B shows various process parameters of the slicing process and the raster patterns 3304a-3304f of the model 3100 at different slice levels. Slice layer shows how a particular inner feature of a hole was captured quite clearly showing the quality of slice levels that can be achieved.

The advantages and disadvantages offered by the STL and STEP based methods can be seen from Table 1. A comparison has been drawn by the two methods of slicing in terms of file storage and processing time. All results are obtained from a Pentium4 2 Ghz, 1 GB RAM system. While direct slicing takes more time to process, it has comparatively less storage space and file check routines. Though the STL format is the quickest method to slice models, they involve higher storage costs and may require file checks and repair routines depending on the complexity of the surface.

TABLE 1
STL and STEP based slicing comparisons

| Name | Format | Features | | File Size | | Time* |
|---|---|---|---|---|---|---|
| Foot | STEP | 19 | NURB | 164 | KB | 48 sec |
| | STL | 200,000 | tri | 45.9 | MB | 6 sec |
| Sinus Graft | STEP | 78 | NURB | 924 | KB | 72 sec |
| Model - 1 | STL | 33878 | tri | 8.55 | MB | Failed |
| Sinus Graft | STEP | 135 | NURB | 1.09 | MB | 76 sec |
| Model - 3 | STL | 333120 | tri | 23.2 | MB | 2 sec |
| Sinus Graft | STEP | 263 | NURB | 485 | KB | 73 sec |
| Model - 4 | STL | 120,000 | tri | 32 | MB | 5 sec |
| Cone | STEP | 102 | NURB | 860 | KB | 71 sec |
| | STL | 52,868 | tri | 12.25 | MB | 2 sec |
| Sphere | STEP | 14 | NURB | 78.5 | KB | 53 sec |
| | STL | 77,999 | tri | 18.6 | MB | 3 sec |

### CONCLUSION

Direct Slicing of CAD model promises to offset the disadvantages posed by the STL format. It does not involve any file repair routines and file sizes are much smaller to handle. It also facilitates the possibility of slicing multi-material volumes or heterogeneous models, a definite advantage over STL files. Since the exact representation is used, complete design information is carried over to the fabrication stage with no loss in information. Although direct slicing does take longer to slice, this problem can be offset by efficient algorithms in terms of reducing memory usage and faster computing power. A point to note is also a careful selection of the subdivision factor and the tolerance value. We have found that under continued trials, an intuition is developed on the selection of the right parameters which works best for the models. Future research would involve the development of an adaptive direct slicing method on heterogeneous models and an appropriate slice layer format in terms of STEP that would be able to transfer slice information across different RP platforms. Effort would also be put into quantifying the exact accuracy obtained by direct slicing rather than using the STL format.

Although specific embodiments of and examples for the reader and method of the invention are described herein for illustrative purposes, various equivalent modifications can be made without departing from the spirit and scope of the invention, as will be recognized by those skilled in the relevant art. The teachings provided herein can be applied to other rapid-prototyping systems, not necessarily the exemplary bio-medical device design and fabrication system generally described above.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. patent application Ser. No. 09/828,504, filed Apr. 5, 2001, and entitled “SYSTEM AND METHOD FOR RAPIDLY CUSTOMIZING A DESIGN AND REMOTELY MANUFACTURING BIOMEDICAL DEVICES USING A COMPUTER SYSTEM”; U.S. patent application Ser. No. 09/972,832, filed Oct. 5, 2001, and entitled “SYSTEM AND METHOD FOR RAPIDLY CUSTOMIZING DESIGN, MANUFACTURE AND/OR SELECTION OF BIOMEDICAL DEVICES”; U.S. Provisional Application No. 60/462,954, filed Apr. 14, 2003, and entitled “DIRECT SLICING OF STEP BASED NURBS MODELS FOR SOLID FREEFORM FABRICATION,”; and U.S. Provisional Application No. 60/487,463, filed Jul. 15, 2003, and entitled “APPARATUS, METHOD AND ARTICLE FOR DIRECT SLICING OF STEP BASED NURBS MODELS FOR SOLID FREEFORM FABRICATION,” are incorporated herein by reference, in their entirety. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all embodiments that operate in accordance with the claims. Accordingly, the invention is not limited by the disclosure, but instead its scope is to be determined entirely by the following claims.

1. A method for use in solid freeform fabrication, the method comprising:
receiving a computer-aided design (CAD) model in a cross-platform compatible format, the CAD model comprising at least one untessellated mathematical representation of one or more surfaces; and
adaptively slicing at least one of the surfaces in the CAD model to produce at least a first set of sliced data.

2. The method of claim 1 wherein adaptively slicing at least one of the surfaces in the CAD model to produce at least a first set of sliced data comprises:
determining a plurality of bounding boxes on the at least one surface;
casting a ray within a slicing plane;
determining which of the bounding boxes the ray passes through; and
for each of the determined bounding boxes which the ray passes through, determining at least one intersection point of the ray and the at least one surface of the CAD model.

3. The method of claim 1 wherein adaptively slicing at least one of the surfaces in the CAD model to produce at least a first set of sliced data comprises:
determining a number of slicing planes;
for each of the determined slicing planes,
subdividing the at least one surface of the CAD model into a plurality of domains;
determining a plurality of bounding boxes based on each of the domains;
for each of a number of positions within the slicing plane, casting a ray at the position within the slicing plane;
determining which of the bounding boxes the ray passes through; and
for each of the bounding boxes through which the ray passes, determining at least one intersection point of the ray and the at least one surface of the CAD model.

4. The method of claim 3, further comprising:
optimizing the at least one untessellated mathematical representation of one or more surfaces of the CAD model before adaptively slicing the at least one of the surfaces in the CAD model to produce the at least a first set of sliced data.

5. The method of claim 3 wherein determining a plurality of bounding boxes based on each of the domains comprises determining a plurality of parallelepipeds having a number of edges, the edges of each parallelepiped oriented parallel to a set of coordinate axes of the CAD model.

6. The method of claim 3 wherein determining a plurality of bounding boxes based on each of the domains comprises determining a size of each of the bounding boxes based on an amount of curvature of a portion of the at least one surface of the CAD model inside a respective one of the bounding boxes.

7. The method of claim 3 wherein determining a plurality of bounding boxes based on each of the domains comprises determining a size of each of the bounding boxes sufficiently small to contain no more than one intersection point of the ray and the at least one surface of the CAD model.

8. The method of claim 3 wherein determining at least one intersection point of the ray and the at least one surface of the CAD model comprises iteratively bisecting the bounding boxes until the first of 1) an error value is within a defined tolerance and 2) the number of iterations exceeds a defined threshold number of iterations.

9. The method of claim 8 wherein determining at least one intersection point of the ray and the at least one surface of the CAD model comprises iteratively bisecting the bounding boxes using at least one of linear interpolation, Newton iteration and fixed point iteration.

10. The method of claim 3 wherein determining the intersection point of the ray and the at least one surface of the CAD model further comprises for each of the intersection points characterizing the intersection point as one of an entrance point, an exit point and an edge point.

11. The method of claim 3 wherein determining a number of slicing planes comprises determining successive slicing planes separated from one another by a thickness corresponding to a thickness of a layer used in a layered manufacturing technique.

12. The method of claim 1 wherein receiving a computer-aided design (CAD) model in a cross-platform compatible format, the CAD model comprising at least one untessellated mathematical representation of one or more surfaces comprises receiving a STEP file comprising a non-uniform rational B-spline representation of the at least one surface representing a three-dimensional solid CAD model.

13. The method of claim 1, further comprising:
determining a set of process planning instructions for three-dimensional printing based on the sliced data, the set of processing planning instructions comprising a raster pattern of points extending between an entrance intersection point and an exit intersection point.

14. The method of claim 4 wherein optimizing the at least one untessellated mathematical representation of one or more surfaces of the CAD model comprises:
mathematically rotating the CAD model incrementally through a plurality of first rotations about a first axis;
determining which of the first rotations of the CAD model produces at least one of a minimum height of a build bed, a minimum volume of supports and a minimum surface area of stair case effect, in three-dimensional printing;
mathematically rotating the determined first-rotated CAD model about a second axis incrementally through a plurality of second rotations;
determining which of the second rotations of the CAD model produces at least one of a minimum height of a build bed, a minimum volume of supports and a minimum surface area of stair case effect, in three-dimensional printing; and
translating the determined second-rotated CAD model.

15. A computer-readable medium storing instructions for causing a computer to produce sliced data use in solid freeform fabrication, by:
receiving a computer-aided design (CAD) model in a cross-platform compatible format, the CAD model comprising at least one untessellated mathematical representation of one or more surfaces; and
adaptively slicing at least one of the surfaces in the CAD model to produce at least a first set of sliced data.

16. The computer-readable medium of claim 15 wherein the instructions cause the computer to adaptively slice the at least one of the surfaces in the CAD model to produce at least a first set of sliced data by:
determining a number of slicing planes;
for each of the determined slicing planes,
subdividing the at least one surface of the CAD model into a plurality of domains;
determining a plurality of bounding boxes based on each of the domains;
for each of a number of positions within the slicing plane, casting a ray at the position within the slicing plane;
determining the bounding boxes which the ray passes through; and
for each of the bounding boxes through which the ray passes, determining at least one intersection point of the ray and the at least one surface of the CAD model.

17. The computer-readable medium of claim 15 wherein the instructions cause the computer produce sliced data for use in solid freeform fabrication, further by:
optimizing the at least one untessellated mathematical representation of one or more surfaces of the CAD model before adaptively slicing the at least one of the surfaces in the CAD model to produce the at least a first set of sliced data.

18. The computer-readable medium of claim 15 wherein the instructions cause the computer to determine a plurality of bounding boxes based on each of the domains by:
determining a size of each of the bounding boxes based on an amount of curvature of a portion of the at least one surface of the CAD model inside a respective one of the bounding boxes.

19. A computer programmed to produce sliced data use in solid freeform fabrication, the computer comprising:
means for receiving a computer-aided design (CAD) model in a cross-platform compatible format, the CAD model comprising at least one untessellated mathematical representation of one or more surfaces; and
means for adaptively slicing at least one of the surfaces in the CAD model to produce at least a first set of sliced data.

20. The computer of claim 19 wherein the means for adaptively slicing the at least one of the surfaces in the CAD model to produce at least a first set of sliced data comprises:
means for determining a number of slicing planes;
means for subdividing the at least one surface of the CAD model into a plurality of domains;
means for determining a plurality of bounding boxes based on each of the domains;
means for casting a ray at the position within the slicing plane;
means for determining the bounding boxes the ray passes through; and
means for determining at least one intersection point of the ray and the at least one surface of the CAD model for each of the bounding boxes through which the ray passes.

21. The computer of claim 19, further comprising:
means for optimizing the at least one untessellated mathematical representation of one or more surfaces of the CAD model before adaptively slicing the at least one of the surfaces in the CAD model to produce the at least a first set of sliced data.

22. A method for use in solid freeform fabrication, the method comprising:
receiving a computer-aided design (CAD) model in a cross-platform compatible format, the CAD model comprising at least one untessellated mathematical representation of one or more surfaces; and
optimizing the at least one untessellated mathematical representation of one or more surfaces of the CAD model.

23. The method of claim 22 wherein optimizing the at least one untessellated mathematical representation of one or more surfaces of the CAD model comprises:
mathematically rotating the CAD model incrementally through a plurality of first rotations about a first axis; and
determining which of the first rotations of the CAD model produces a minimum value of at least one of: a build height, a volume of supports and a stair cased surface area.

24. The method of claim 22 wherein optimizing the at least one untessellated mathematical representation of one or more surfaces of the CAD model comprises:
mathematically rotating the CAD model incrementally through a plurality of first rotations about a first axis; and
determining which of the first rotations of the CAD model produces a minimum value of at least two of: a build height, a volume of supports and a stair cased surface area.

25. The method of claim 22 wherein optimizing the at least one untessellated mathematical representation of one or more surfaces of the CAD model comprises:
mathematically rotating the CAD model incrementally through a plurality of first rotations about a first axis;
determining which of the first rotations of the CAD model produces a minimum value of at least one of: a build height, a volume of supports and a stair cased surface area;
mathematically rotating the determined first-rotated CAD model about a second axis incrementally through a plurality of second rotations; and
determining which of the second rotations of the CAD model produces a minimum value of at least one of: the build height, the volume of supports and the stair cased surface area.

26. The method of claim 22 wherein optimizing the at least one untessellated mathematical representation of one or more surfaces of the CAD model comprises:
mathematically rotating the CAD model incrementally through a plurality of first rotations about a first axis;
determining which of the first rotations of the CAD model produces a minimum value of at least two of: a build height, volume of supports and a stair cased surface area according to a first weighting;
mathematically rotating the determined first-rotated CAD model about a second axis incrementally through a plurality of second rotations; and
determining which of the second rotations of the CAD model produces a minimum value of at least one of: the build height, the volume of supports and the stair cased surface area according to a second weighting.

27. The method of claim 22 wherein optimizing the at least one untessellated mathematical representation of one or more surfaces of the CAD model comprises:
mathematically rotating the CAD model incrementally through a plurality of first rotations about a first axis;
determining which of the first rotations of the CAD model provides a minimum height of a build bed in three-dimensional printing;
mathematically rotating the determined first-rotated CAD model about a second axis incrementally through a plurality of second rotations; and
determining which of the second rotations of the CAD model produces a minimum height of the build bed in three-dimensional printing.

28. The method of claim 22 wherein optimizing the at least one untessellated mathematical representation of one or more surfaces of the CAD model comprises:
mathematically rotating the CAD model incrementally through a plurality of first rotations about a first axis;
determining which of the first rotations of the CAD model provides a minimum height of a build bed in three-dimensional printing;
mathematically rotating the determined first-rotated CAD model about a second axis incrementally through a plurality of second rotations, the second axis orthogonal to the first axis; and
determining which of the second rotations of the CAD model produces the minimum height of a build bed in three-dimensional printing.

29. The method of claim 22 wherein optimizing the at least one untessellated mathematical representation of one or more surfaces of the CAD model comprises:
mathematically rotating the CAD model incrementally through a plurality of first rotations about a first axis;
determining which of the first rotations of the CAD model provides a minimum height of a build bed in three-dimensional printing;
mathematically rotating the determined first-rotated CAD model about a second axis incrementally through a plurality of second rotations, the second axis orthogonal to the first axis;
determining which of the second rotations of the CAD model produces a minimum height of the build bed in three-dimensional printing; and
translating the determined second-rotated CAD model.

30. The method of claim 29 wherein mathematically rotating the CAD model incrementally through a plurality of first rotations about a first axis comprises applying the transformation defined by:
$$[ \begin{matrix}{X}^{′} \\ {Y}^{′} \\ {Z}^{′}\end{matrix} ] = [ \begin{matrix}1 & 0 & 0 \\ 0 & cos ( θ ) & - sin ( θ ) \\ 0 & sin ( θ ) & cos ( θ )\end{matrix} ] [ \begin{matrix}X \\ Y \\ Z\end{matrix} ]$$
where X,Y,Z represent control points of different NURBS surfaces of the CAD the model, X′,Y′,Z′ represent a set of new control points resulting from the transformation, and Θ represents an angle of transformation, and wherein mathematically rotating the determined first-rotated CAD model about a second axis incrementally through a plurality of second rotations, the second axis orthogonal to the first axis comprises applying the transformation defined by:
$$[ \begin{matrix}{X}^{′} \\ {Y}^{′} \\ {Z}^{′}\end{matrix} ] = [ \begin{matrix}cos ( θ ) & 0 & - sin ( θ ) \\ 0 & 1 & 0 \\ sin ( θ ) & 0 & cos ( θ )\end{matrix} ] [ \begin{matrix}X \\ Y \\ Z\end{matrix} ] .$$

31. The method of claim 30, further comprising,
adaptively slicing at least one of the surfaces in the CAD model to produce at least a first set of sliced data.

32. A computer-readable medium storing instructions for causing a computer produce model data for use in solid freeform fabrication, by:
receiving a computer-aided design (CAD) model in a cross-platform compatible format, the CAD model comprising at least one untessellated mathematical representation of one or more surfaces; and
optimizing the at least one untessellated mathematical representation of one or more surfaces of the CAD model.

33. The computer-readable medium of claim 32 wherein the instructions cause the computer to optimize the at least one untessellated mathematical representation of one or more surfaces of the CAD model by:
mathematically rotating the CAD model incrementally through a plurality of first rotations about a first axis;
determining which of the first rotations of the CAD model produces a minimum value of at least one of: a build height, a volume of supports and a stair cased surface area;
mathematically rotating the determined first-rotated CAD model about a second axis incrementally through a plurality of second rotations; and
determining which of the second rotations of the CAD model produces a minimum value of at least one of: the build height, the volume of supports and the stair cased surface area.

34. The computer-readable medium of claim 32 wherein the instructions cause the computer to optimize the at least one untessellated mathematical representation of one or more surfaces of the CAD model by:
mathematically rotating the CAD model incrementally through a plurality of first rotations about a first axis;
determining which of the first rotations of the CAD model produces a minimum value of at least two of: a build height, volume of supports and a stair cased surface area according to a first weighting;
mathematically rotating the determined first-rotated CAD model about a second axis incrementally through a plurality of second rotations; and
determining which of the second rotations of the CAD model produces a minimum value of at least one of: the build height, the volume of supports and the stair cased surface area according to a second weighting.

35. The computer-readable medium of claim 32 wherein the instructions cause the computer to optimize the at least one untessellated mathematical representation of one or more surfaces of the CAD model by:
mathematically rotating the CAD model incrementally through a plurality of first rotations about a first axis;
determining which of the first rotations of the CAD model provides a minimum height of a build bed in three-dimensional printing;
mathematically rotating the determined first-rotated CAD model about a second axis incrementally through a plurality of second rotations, the second axis orthogonal to the first axis; and
determining which of the second rotations of the CAD model produces a minimum height of the build bed in three-dimensional printing.

36. The computer-readable medium of claim 32 wherein the instructions cause the computer to optimize the at least one untessellated mathematical representation of one or more surfaces of the CAD model by:
mathematically rotating the CAD model incrementally through a plurality of first rotations about a first axis according to the transformation:
$$[ \begin{matrix}{X}^{′} \\ {Y}^{′} \\ {Z}^{′}\end{matrix} ] = [ \begin{matrix}1 & 0 & 0 \\ 0 & cos ( θ ) & - sin ( θ ) \\ 0 & sin ( θ ) & cos ( θ )\end{matrix} ] [ \begin{matrix}X \\ Y \\ Z\end{matrix} ] ;$$
determining which of the first rotations of the CAD model provides a minimum height of a build bed in three-dimensional printing;
mathematically rotating the determined first-rotated CAD model about a second axis incrementally through a plurality of second rotations according to the transformation:
$$[ \begin{matrix}{X}^{′} \\ {Y}^{′} \\ {Z}^{′}\end{matrix} ] = [ \begin{matrix}cos ( θ ) & 0 & - sin ( θ ) \\ 0 & 1 & 0 \\ sin ( θ ) & 0 & cos ( θ )\end{matrix} ] [ \begin{matrix}X \\ Y \\ Z\end{matrix} ] ,$$
the second axis orthogonal to the first axis; and
determining which of the second rotations of the CAD model produces the minimum height of a build bed in three-dimensional printing.

37. A computer programmed to produce model data use in solid freeform fabrication, by:
receiving a computer-aided design (CAD) model in a cross-platform compatible format, the CAD model comprising at least one untessellated mathematical representation of one or more surfaces; and
optimizing the at least one untessellated mathematical representation of one or more surfaces of the CAD model.

38. The computer of claim 37 wherein the instructions cause the computer to optimize the at least one untessellated mathematical representation of one or more surfaces of the CAD model by:
mathematically rotating the CAD model incrementally through a plurality of first rotations about a first axis;
determining which of the first rotations of the CAD model produces a minimum value of at least two of: a build height, volume of supports and a stair cased surface area according to a first weighting;
mathematically rotating the determined first-rotated CAD model about a second axis incrementally through a plurality of second rotations; and
determining which of the second rotations of the CAD model produces a minimum value of at least one of: the build height, the volume of supports and the stair cased surface area according to a second weighting.

39. The computer of claim 37 wherein the instructions cause the computer to optimize the at least one untessellated mathematical representation of one or more surfaces of the CAD model by:
mathematically rotating the CAD model incrementally through a plurality of first rotations about a first axis according to the transformation:
$$[ \begin{matrix}{X}^{′} \\ {Y}^{′} \\ {Z}^{′}\end{matrix} ] = [ \begin{matrix}1 & 0 & 0 \\ 0 & cos ( θ ) & - sin ( θ ) \\ 0 & sin ( θ ) & cos ( θ )\end{matrix} ] [ \begin{matrix}X \\ Y \\ Z\end{matrix} ] ;$$
determining which of the first rotations of the CAD model provides a minimum height of a build bed in three-dimensional printing;
mathematically rotating the determined first-rotated CAD model about a second axis incrementally through a plurality of second rotations according to the transformation:
$$[ \begin{matrix}{X}^{′} \\ {Y}^{′} \\ {Z}^{′}\end{matrix} ] = [ \begin{matrix}cos ( θ ) & 0 & - sin ( θ ) \\ 0 & 1 & 0 \\ sin ( θ ) & 0 & cos ( θ )\end{matrix} ] [ \begin{matrix}X \\ Y \\ Z\end{matrix} ] ,$$
the second axis orthogonal to the first axis; and
determining which of the second rotations of the CAD model produces the minimum height of a build bed in three-dimensional printing.
